(19) United States
(12) Patent Application Publication
(10) Pub. No.: US 2025/0121373 A1
(43) Pub. Date: Apr. 17, 2025

(54) Droplet Robotic System Enabled by Electret-induced Polarization on Droplet

(71) Applicants: The University of Hong Kong, Hong Kong (CN); Advanced Biomedical Instrumentation Centre Limited, Hong Kong (CN)

(72) Inventors: Ruotong Zhang, Hong Kong (CN); Ho Cheung Shum, Hong Kong (CN); Haisong Lin, Hong Kong (CN)

(73) Assignees: The University of Hong Kong, Hong Kong (CN); Advanced Biomedical Instrumentation Centre Limited, Hong Kong (CN)

(21) Appl. No.: 18/910,845

(22) Filed: Oct. 9, 2024

Related U.S. Application Data
(60) Provisional application No. 63/589,497, filed on Oct. 11, 2023.
(60) Provisional application No. 63/590,701, filed on Oct. 16, 2023.

(51) Int. Cl. B01L 3/00

(52) U.S. Cl. CPC B01L 3/502792; B01L 2400/043

(57) ABSTRACT

A droplet gripper for a polarizable droplet including a top plate formed of magnetically responsive material and movable in a defined sequence in response to a regionalized electromagnetic field. The gripper further has electret sheets downwardly depending from the top plate. The electret sheets are separated from each other and are chargeable to the same polarities so as to capture the droplet between them due to electret-induced polarization on droplet (EPD). The gripper may be included in a Multiphysics droplet robotic system for automatically manipulating and moving a liquid droplet. The system includes a programmable control matrix that generates a movable regionalized electromagnetic field through coils so as to engage the magnetic material on the top plate and move the EPD gripper and a captured polarizable drop in the defined sequence along a specific path as well as to achieve other microfluidic operations according to a control matrix program.

### CROSS-REFERENCE TO RELATED PATENT APPLICATIONS

This application claims the benefit of priority under 35 U.S.C. Section 119 (e) of U.S. Application No. 63/589,497, filed Oct. 11, 2023, and U.S. Application No. 63/590,701, filed Oct. 16, 2023, both of which are incorporated herein by reference in their entirety.

### FIELD OF THE INVENTION

The present invention relates to automated liquid manipulation and, more particularly, to automated droplet manipulation using electrostatic fields.

### BACKGROUND OF THE INVENTION

Robotic systems have begun to inspire a transformation in scientific research from labor-intensive empirical practices to automated standardized operations due to their high efficiency, precision, and reliability [1-3]. They have displayed potential to accelerate drug discovery [4-6], synthesize precision materials and structures [7-9], and facilitate medical diagnostics [10-12]. For these applications, automated liquid manipulation is one of the imperative functions since samples and reagents in liquid format are often involved in scientific research related to biology, chemistry, materials science, and medicine. Automated liquid manipulation can help to increase efficiency with limited labor, while also minimizing manual errors during experimental process [13, 14]. As a result, the demand for automated liquid manipulation platforms continues to grow, with a goal of revolutionizing scientific research experimentation from a manual empirical process to an automated intelligent one.

The current automation of liquid manipulation is mainly based on liquid handling workstations, which transfer liquids by controlling experimental consumables, such as pipettes, centrifuge tubes, microplates, etc. [15-17] These workstations are bulky, resource-intensive (requiring additional laboratory environment and resources), and functionally limited. The prohibitive cost of such systems, compounded by the insufficient flexibility and limited scalability, has constrained their widespread adoption. [18-20] Moreover, commercial systems are typically non-modular and are not open source [19-21], further constraining their scalability and widespread adoption in labs. To overcome these challenges, droplet robotic systems for manipulating discrete fluids have been proposed. [12, 21, 22] Compared with the bulky robotic arms, droplet robotic systems offer miniaturization, affordability, and flexibility. They can process extremely small volumes of liquids and can achieve spatial crossover manipulation so as to process multiple droplets in parallel. [11, 23-26] In addition, due to their small footprint and flexible operation, droplet robotic systems can be easily integrated into other laboratory automation systems. [27-29] However, they still face challenges with compatibility for various liquid types and biochemical samples. [28-30]

The existing common techniques for automated droplet manipulation include air-based and oil-based electrowetting-on-dielectric (EWOD) as well as magnetic, acoustic and thermal-based systems. FIGS. 1A-D. [30-34] However, the hardware platforms based on these droplet manipulation techniques lack compatibility with different liquid types and the biochemical samples carried within the droplets. For example, EWOD is not suitable for manipulating liquids with low permittivity and poor conductivity [35, 36], and also shows problems with protein adsorption, creating a challenge for manipulating biological samples without biofouling. [37-39] In the case of magnetic-based systems, the magnetic nanoparticles introduced may react with certain reagents [40, 41] while also interfering with the absorbance of the droplet, resulting in inaccurate test results. Moreover, both surface acoustic waves and heat methods may cause damage to cells or proteins loaded inside the droplet due to the external high energy. Thus, the low level of compatibility of these techniques with various liquid types or biochemical samples requires manual adaptation or replacement when altering sample contents, which not only compromises the accuracy and reproducibility of the results, but also requires extra labor to supervise and modify the platform.

In the article, Veley et al., “On-chip manipulation of free droplets,” Nature 426, 515-516 (2003). https://doi.org/10.1038/426515a, there is described a liquid-liquid microfluidic system for manipulating freely suspended microlitre- and nanolitre-sized droplets of water or hydrocarbon, which float on a denser, perfluorinated oil and are driven by an alternating or constant electric field applied by arrays of electrodes below the oil. There are also a few reports about the application of dielectrophoresis for separating particles in microfluidic channels to achieve droplet manipulation. However, this approach requires special electrode designs and high voltage inputs, so Joule heating and high field strengths can impede the system's biocompatibility.

Another article, Dai et al., “Controllable High-Speed Electrostatic Manipulation of Water Droplets on a Superhydrophobic Surface,” Advanced Materials, Vol. 31, Issue 43 (Oct. 25, 2019) https://doi.org/10.1002/adma.201905449 discloses the use of electrostatic charging for controllable high-speed “all-in-one” no-loss droplet manipulation, that is, in-plane moving and stopping/pinning in any direction on a superhydrophobic surface. In this article, a droplet that has been pre-charged to a certain level is forced to move in or against the direction of the electric field. However, if the force induced by the droplet net charge is expected to dominate the actuation, the charge density of the droplet needs to be kept at a high level, which may require an extra charging process. Besides, because of the randomness of contact electrification and charge dissipation, as well as the difference in chargeable capacity across liquids, the robustness and feasibility of the net charge-based practical manipulation is yet to be verified.

A further article, Li et al., “Photopyroelectric microfluidics,” Science Advances, Vol. 6, Issue 28 (Sep. 16, 2020) https://www.science.org/doi/10.1126/sciadv.abc1693 describes precision manipulation of various liquids using photopyroelectric microfluidics where irradiation from even one beam of light creates a unique wavy dielectrophoretic force field capable of performing desired loss-free manipulation of droplets. In this article, photothermal film composed of graphene-polymer composite is used. This film senses the light stimuli and responds by generating a localized and uneven thermogenesis. Consequently, a pyroelectric crystal converts the heat into extra electric charges, forming a wavy dielectrophoretic force profile that can trap, dispense, and split fluids. The process includes the energy conversion of light to thermal to electricity and requires a specific substrate. Besides, the heat generated may have an extra effect on the activity of bio-samples.

### SUMMARY OF THE INVENTION

According to the present invention, a droplet robotic system based on the mechanism of electret-induced polarization on droplet (EPD) is proposed. Instead of the conventional AC/DC power supply with fixed electrodes, EPD directly utilizes the intrinsic electrostatic charge carried on electrets to generate a non-uniform electrostatic field, polarizing and attracting the droplets. EPD theoretically enables all-liquid actuation and experimentally exhibits generality in actuating various conductive/non-conductive and inorganic/organic liquids. Moreover, its natural independence from high voltage AC/DC power supplies or external additives ensures its compatibility with bio-samples (body fluids/living cells/proteins).

Based on the EPD mechanism, a Multiphysics droplet robotic system is designed to automate the droplet manipulation process. The system consists of: (1) a programmable control matrix that generates a regionalized electromagnetic field by exciting coils; (2) EPD grippers made of a hybrid of electret and magnetically responsive materials, which can be controlled by the programmable magnetic field and can induce a mobile non-uniform electrostatic field capable of attracting the droplet below; and (3) a target droplet sample. By programming the control matrix, coils can be powered in a defined sequence so that the EPD gripper can drive droplets in a specific path as well as achieve other microfluidic operations.

EPD utilizes the polarization of dielectrics in a non-uniform electrostatic field, thus demonstrating the potential of manipulating non-aqueous or non-conductive liquids. Based on both simulations and experimental results, EPD has proved that it possesses generality for various inorganic/organic liquids, while the variations in droplet volume (nL-mL), electrical conductivity, and relative permittivity (2.25-84.2) over common ranges would not prohibit the manipulation of liquids. Furthermore, the external stimulus required for EPD actuation is a non-uniform electrostatic field, which avoids the effect of Joule heating on biological samples and thus guarantees the compatibility of various bio-samples, such as body fluids, proteins, and living cells.

To provide automation, a Multiphysics system is designed to couple with EPD, which system includes a programmable control matrix that generates a regionalized electromagnetic field, EPD grippers which can be controlled by the programmable magnetic field and induce mobile non-uniform electrostatic field and a target droplet that can be polarized. Its advantages in generality of operable liquids, biocompatibility, and programmability endow it with the potential to assist basic scientific investigation as an automated experimental platform.

Compared with the existing droplet robotic systems, the proposed EPD-based droplet robotics system has significant advantages in terms of operable liquid types and compatibility with biochemical samples and substrates. Besides, it also exhibits overwhelmingly collective performances over other platforms in terms of programmability, cost of fabrication, power consumption, and compatibility with substrates, thus laying the foundation for an automated experimental platform in multidisciplinary fields.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A is a schematic diagram of the existing common techniques for automated droplet manipulation, i.e., electrowetting-on-dielectric (EWOD),

FIG. 1B shows a magnetic-based droplet actuation,

FIG. 1C shows acoustic-based droplet actuation, and

FIG. 1D shows thermal-based droplet actuation;

FIG. 2A shows the working principle of the droplet robotic system based on the mechanism of electret-induced polarization on droplet (EPD),

FIG. 2B is an optical image of the EPD-based Multiphysics droplet robotic system and its core components,

FIG. 2C shows overlaid sequential images that visualize the moving path of the droplet actuated by EPD-based Multiphysics droplet robotic system and

FIG. 2D shows bar graph comparisons between the proposed EPD-based droplet robotic system and the existing automated droplet robotic system from 6 perspectives;

FIG. 3A shows graphs comparing EPD and EWOD for water (inorganic),

FIG. 3B shows the comparison of glycerol (alcohol),

FIG. 3C shows the comparison of triacetin (ester),

FIG. 3D shows the comparison for serum,

FIG. 3E shows the comparison for saliva and

FIG. 3F shows the comparison for urine;

FIG. 4A is an optical image of the electret-induced actuation of a droplet floating on an oil surface and two potential hypotheses to explain the phenomenon,

FIG. 4B shows actuation of the droplet by two electrets carrying opposite charge polarities to investigate the dominating hypothesis,

FIG. 4C illustrates a simulation of the droplet carrying a measured amount of positive charge attracted by both positive and negative electrets,

FIG. 4D illustrates a simulation of the average Maxwell surface stress tensor applied on droplets with positive, negative, and neutral charge densities,

FIG. 4E show a variation trend comparison between the experimentally measured acceleration of EPD-based droplet actuation and the simulated Maxwell stress tensor applied to a droplet,

FIG. 4F shows droplet's actuation path under EPD effect,

FIG. 4G shows the relationship between the effective actuation distance of the droplet and the charge amount of the electret and

FIG. 4H is a phase diagram of the droplet's dynamic behaviors when adjusting the electret's charge amount and the height difference between the electret and droplet;

FIG. 5A illustrates the simulated ∇E² generated by positive electret (glass) and the average Maxwell stress tensor exerted on the droplet carrying a measured amount of positive charge and a graph of the simulated average Maxwell stress tensor applied on a droplet by electrets with different charge amounts and

FIG. 5B illustrates the simulated ∇E² generated by negative electret (PTFE) and the average Maxwell stress tensor exerted on the droplet carrying a measured amount of positive charge;

FIG. 6A is a simulation of the actuation of a droplet by ∇E² generated by a positive electret (glass) and the average Maxwell stress tensor exerted on the droplet carrying a measured amount of positive charge and

FIG. 6B is a simulated ∇E² generated by a negative electret (PTFE) and the average Maxwell stress tensor exerted on the droplet carrying a measured amount of positive charge;

FIG. 7A is a schematic diagram of EPD's generality with various liquids,

FIG. 7B shows EPD-based actuation of droplets with volumes ranging from nanoliters to milliliters,

FIG. 7C shows a simulated Maxwell stress tensor applied on droplets with different conductivities,

FIG. 7D shows a simulated Maxwell stress tensor applied on droplets with different relative permittivity,

FIG. 7E shows optical images of EPD-based droplet actuation,

FIG. 7F illustrates a simulated effective actuation distance of water, triacetin and paraffin (star symbol) obtained from a crossing between the calculated Maxwell stress tensor (solid line) and the minimum force required for effective actuation (dash line) and

FIG. 7G shows a comparison between the simulated and the measured effective actuation distance (EAD);

FIG. 8 is an illustration of the EPD-based actuation of multiple droplets;

FIG. 9 is a graph showing the calculation of the force needed for effective actuation;

FIG. 10A is a schematic diagram of EPD's compatibility with bio-samples,

FIG. 10B shows optical images of EPD-based actuation of body fluids,

FIG. 10C shows a series of photos under a fluorescence microscope showing the EPD-based actuation of fluorescent protein solution,

FIG. 10D shows an EPD-based actuation of living A549 cells within a culture medium, where the percentage of living cells is analyzed and compared with the control group in air,

FIG. 10E illustrates a variation of viable and nonviable cell concentrations after being treated on EPD/EWOD and then incubated,

FIG. 10F is a schematic diagram of EPD's compatibility with various substrates,

FIG. 10G is an optical image showing the EPD-based droplet actuation on a hydrophobic surface,

FIG. 10H is an optical image showing the EPD-based actuation of a droplet floating on the an oil surface and a graph showing the effect of a surfactant and

FIG. 10I shows optical images of the EPD-based actuation of droplet merged in an oil surrounding, with a hydrophobic substrate;

FIG. 11 is photos of droplets taken with a fluorescence microscope showing the protein adsorption on double-plate EWOD after actuation;

FIG. 12A shows the maximum actuation voltages of serum, saliva, and urine on oil-based EWOD without droplet fragmentation and

FIG. 12B shows graphs of the actuation of human serum, saliva, and urine on oil-based EWOD with a working voltage of 65 V (highest voltage preventing all three body fluids from fragmentation);

FIG. 13A shows actuation of 0.05 mg/mL FITC-BSA on oil-based EWOD with working voltage of 100 V, in which droplet fragmentation happens and prevents subsequent continuous actuation and

FIG. 13B shows fluorescence microscope images illustrating the protein adsorption on oil-based EWOD after actuating a droplet of 0.05 mg/mL FITC-BSA solution, indicated by the change of fluorescence intensity on the substrate;

FIG. 14A is a bar graph showing the impact of the EPD and electrowetting effects on cell activity and

FIG. 14B is a bar graph showing the impact of EPD and oil-based EWOD system setup on cell culture;

FIG. 15A shows on the right side an illustration of EPD-based actuation of a 10% water-in-oil emulsion, while the right side is an optical image showing the inside of the emulsion,

FIG. 15B shows on the right side an illustration of EPD-based actuation of a 10% oil-in water emulsion, while the right side is an optical image showing the inside of the emulsion and

FIG. 15C is an optical images showing EPD-based actuation of particles-in-water (iron oxide magnetic nanoparticles);

FIG. 16A is an SEM image of the surface morphology of a superhydrophobic surface and

FIG. 16B shows the measurement of the contact angle of the superhydrophobic surface;

FIG. 17 illustrates EPD-based droplet actuation on hydrophilic surface showing that the droplet exhibits a tendency to move with different contact angles on advancing and receding sides;

FIG. 18 shows the adjustment of the maximum actuation velocity by introducing surface surfactant in oil substrate;

FIG. 19 shows graphs comparing droplet evaporation on the hydrophobic substrate and oil substrate;

FIG. 20A is a schematic diagram of the Multiphysics droplet robotic system of the present invention,

FIG. 20B shows the general workflow of the proposed Multiphysics droplet robotic system,

FIG. 20C is an optical image of the programmable control matrix fabricated on a multilayer PCB,

FIG. 20D is an operational schematic of the control matrix and corresponding simulation result,

FIG. 20E is a diagram of the EPD gripper,

FIG. 20F is a simulated electric field strength of the EPD gripper (bottom view),

FIG. 20G is an illustration of the force generated by the EPD gripper in X direction (left) and Y direction (right) on the droplet at different locations,

FIG. 20H is a simulated magnetic Maxwell stress tensor on the EPD gripper and an electric maxwell stress tensor on a target droplet;

FIG. 21A shows the side view of the simulated electric potential distribution of the EPD gripper and

FIG. 21B shows the bottom view of the simulated electric potential distribution;

FIG. 22 shows the locations of the four stable equilibrium points generated by EPD gripper according to the simulation result;

FIG. 23A is a simulation of the X component of the force generated by a slice-shape electret that is exerted on the droplet at different locations and

FIG. 23B is the Y component of the force exerted on the droplet at different locations, with force stable equilibrium points labelled with arrows;

FIG. 24 is a comparison of the force generated by slice-shape and gripper-shape electrets on the droplet;

FIG. 25 shows the resolution and precision of EPD compared to EWOD and magnetic-based system in experiments;

FIG. 26A shows self-assembly of multiple droplets, which is one of the basic microfluidic functions which can be performed by the EPD-based droplet robotic system,

FIG. 26B shows merging of two droplets and

FIG. 26C shows mixing of the merged droplets by cyclic motion;

FIG. 27A is a lateral optical image of the floating water droplet at the oil-air interface,

FIG. 27B is a schematic diagram of two floating water droplets at the oil-air interface, showing the distorted interface will lead to the attractive force,

FIG. 27C shows a simulated EPD force applied on two droplets by EPD gripper, indicating that both droplets are subjected to EPD forces pointing at each other and

FIG. 27D is a plot of the time required for two 20 μL droplets merging, indicating the presence of EPD gripper can help to promote droplet merging;

FIG. 28A is a schematic diagram of different body fluids (serum, saliva, and urine), demonstrating that their conductivity and protein concentration vary greatly,

FIG. 28B shows the characterization of serum, saliva, and urine's actuation on the EPD-based Multiphysics droplet robotic system,

FIG. 28C is an optical image of the EPD-based droplet robotic system and an auxiliary detection chip,

FIG. 28D is an optical image of the microchip setup, which is designed to conduct two calibrations and one test of a real bio-sample detection as a group,

FIG. 28E is a step-by-step workflow of the EPD-based droplet robotic system when performing lithium detection and

FIG. 28F shows comparisons of the tested lithium results of serum, saliva and urine samples the reference values by the EPD-based system;

FIG. 29 shows graphs of the actuation of human serum, saliva, and urine on EWOD with working voltage of 100V and 150V;

FIG. 30 is a set of graphs showing the actuation standard curve for serum lithium, saliva lithium and urine lithium established by measuring the absorbance of calibration samples at 540 nm and 630 nm;

FIG. 31 is a set of graphs showing the standard curve for serum lithium, saliva lithium, and urine lithium established by in-situ photography and RGB analysis;

FIG. 32A is a schematic diagram of the workflow for establishing a cell-bacteria model of inflammation and in-situ detection of the concentration of an inflammatory mediator on EPD-based system,

FIG. 32B is a standard curve of the concentration of human IL-1β and

FIG. 32C is a graph of the detected concentration of human IL-1β after 1st, 2nd, and 3rd infection of bacteria; and

FIG. 33 is an SEM image showing the surface morphology of the microfluidic detection chip.

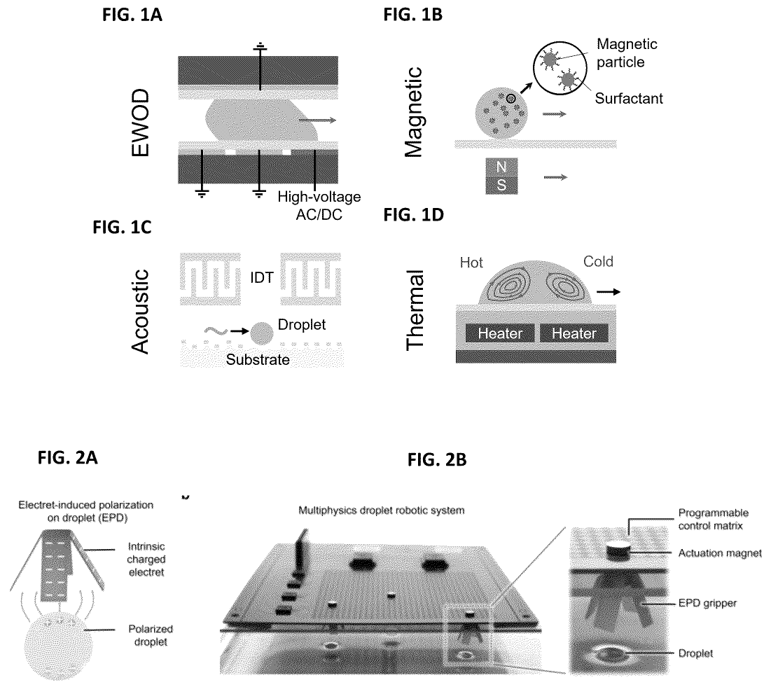

### DETAILED DESCRIPTION OF THE INVENTION

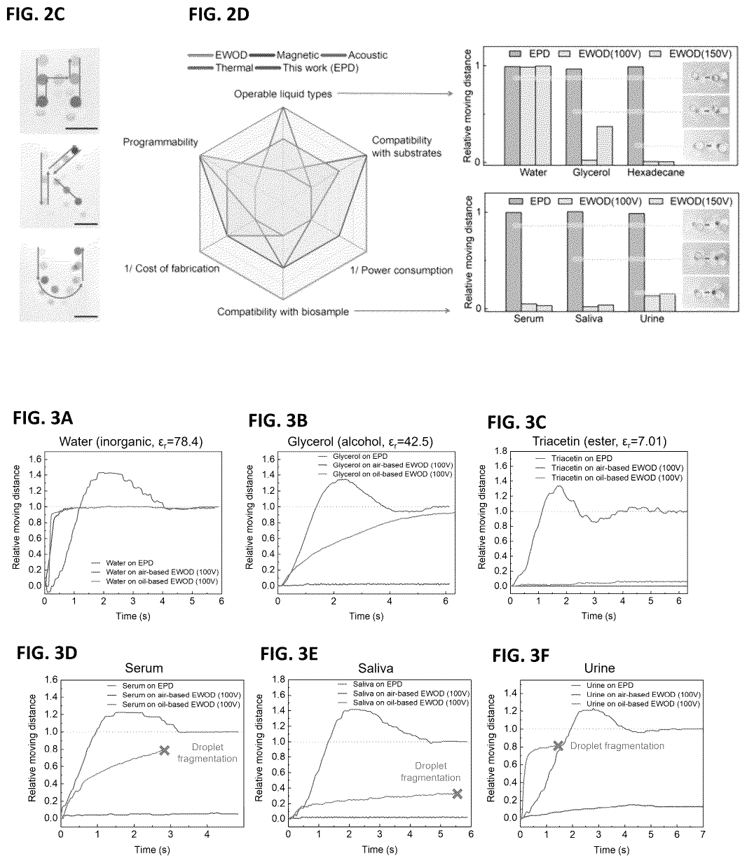

A droplet robotic system based on the mechanism of electret-induced polarization on droplet (EPD) is proposed based on the observed attraction effect between various liquid droplets and electrets. Conventional liquid polarization is generated by AC/DC electric fields [39,73,76]. However, instead of the conventional AC/DC power supply with fixed electrodes, EPD directly utilizes the intrinsic electrostatic charge carried on electrets to generate a non-uniform electrostatic field, polarizing and attracting droplets, as shown in FIG. 2A.

The most fundamental physical principle of EPD can be attributed to polarization, a principle that is indeed already present and discussed in the literature about micro-object actuation [46,83]:

$${F}_{polari 𝓏 aton} = 4 {πε}_{m} {r}^{3} CM ( E \cdot ∇ ) E$$

where E is the electric field strength, r is the radius of the particle, εₘ is the permittivity of the surrounding medium and CM is the Clausius-Mossotti factor related to the effective polarizability of the particle.

The traditional method to polarize liquid is to apply high-frequency and high-voltage AC/DC electric fields in a microfluidic device [84-86,60]. Despite originating from the same governing principle of polarization as AC/DC-induced polarization, the polarization induced by electrostatic charges needs to be discussed separately. The equivalent circuit models are different for the AC/DC-induced and electrostatic charges-induced polarization, where the former model is externally connected by a power supply, while the latter model is an isolated system.

In the model of the AC/DC electric field [86,87], an external power supply connects the upper and lower electrodes and maintains the voltage U constant. In this closed circuit, both conduction and displacement currents exist and compete frequency-dependently. Thus, CM in the equation above should be expressed as [54,69]:

$$CM = Re [ \frac{( {ε}_{d} - j \frac{{σ}_{d}}{ω} ) - ( {ε}_{m} - \frac{{σ}_{d}}{ω} )}{( {ε}_{d} - j \frac{{σ}_{d}}{ω} ) + 2 ( {ε}_{m} - \frac{{σ}_{d}}{ω} )} ]$$

in which ω is the frequency of the applied electric field, ε and σ are the permittivity and electrical conductivity, and the subscripts d and m represent the droplet and the surrounding media, respectively. Therefore, the AC/DC induced polarization is related to both electrical conductivity and permittivity of the operated droplet, and the frequency setup needs to be customized according to the electrical property of the operated droplet [86,60].

As for the isolated system model of the electrostatic charges, there is no conduction current. CM is thus independent of conductivity and frequency, and is only related to the permittivity:

$$CM = \frac{{ε}_{d} - {ε}_{m}}{{ε}_{d} + 2 {ε}_{m}}$$

Besides the expression of CM, E also differs for two kinds of polarization. In the model of AC/DC electric field, the voltage U is maintained as constant. Meanwhile, the charge Q accumulated on the electrode (Q=C·U, supplied by the power source) changes with the overall capacitance C of the system, leading to a variable the electric field strength E [85,87,88]. For example, the equivalent capacitance of the electric double layer at the electrode interface could become very small in some cases [89] (e.g., σₘ below 100 mS/m and field frequency below about 15 kHz 10). At this time, E within the surrounding medium tends to be zero, leading to an undesired shielding effect [90,91].

In contrast, in the equivalent model for polarization induced by electrostatic charges, the charge accumulated on the electret Q is a constant, leading to a stable E:

$$E = {\int }_{{S}_{electret}} \frac{φ dS}{4 {πε}_{m} {d}^{2}}$$

in which φ is the surface charge density of the electret and d is the distance from electret. Based on the analysis above, the polarization induced by AC/DC and electrostatic charges has different impact parameters and limitations due to the difference in their equivalent circuit models.

Based on the newly proposed EPD mechanism, a Multiphysics droplet robotic system is designed to automate the droplet manipulation process (FIG. 2B). The system consists of: (1) a programmable control matrix that generates a regionalized electromagnetic field by exciting coils; (2) EPD grippers made of a hybrid of electret and magnetically responsive materials, which can be controlled by the programmable magnetic field and induce a mobile non-uniform electrostatic field capable of attracting the droplet below and (3) target droplet sample. By programming the control matrix, the EPD gripper can actuate droplets in a specific path, such as the shape of the letter “H”, “K”, “U” (FIG. 2C), as well as other microfluidic operations.

Compared with the existing droplet robotic system, the EPD-based droplet robotics system of the present invention shows significant advantages especially in terms of the range of operable liquid types and compatibility with bio-samples (FIG. 2D). The EPD-based droplet robotic system, in principle, enables all liquid actuation and is experimentally validated for actuating various inorganic/organic liquids, including but not limited to water (inorganic), glycerol (alcohol), and triacetin (ester) (FIG. 2D, FIGS. 3A-3C), with relative permittivity ranging from 2.25 to 84.2. In contrast, EWOD, both air-based and oil-based, faces challenges when actuating organic liquids with low permittivity (e.g. triacetin with relative permittivity of 7.01) due to the limitation of the electrowetting mechanism. The position of the front edge of the droplet normalized by the distance between two neighboring coils/electrodes for FIGS. 3A-3C is defined as the relative moving distance. The result indicates that EWOD faces challenges when actuating organic liquids with low dielectric constants, even when oil surrounding is introduced. In contrast, EPD can actuate them smoothly without changing any of the parameter settings, showing EPD's generality of various liquids

Considering that EPD utilizes the polarization of dielectrics in a non-uniform electrostatic field, it can extend the range of manipulable liquids from conductive or aqueous to dielectric liquids theoretically [35, 43]. Thus, FIGS. 3A and 3B show that, unlike the challenges of driving organic liquids with low permittivity on EWOD, a variety of inorganic/organic liquids, including water, glycerol (alcohol), hexadecane (alkane), are smoothly actuated on the EPD-based droplet robotic system without changing any of the parameter settings. Furthermore, since high voltage electric AC/DC fields are not required in EPD, the undesired effects of Joule heating and high electric field strength on biological samples can be avoided [44-46]. By validating the actuation of multiple human body fluids, including serum, saliva, and urine (FIG. 2D, FIG. 3D-3F), as well as solutions of protein and living cells on EPD and EWOD, EPD shows a superior compatibility with bio-samples. In FIGS. 3D-3F the position of the front edge of the droplet normalized by the distance between two neighboring coils/electrodes is defined as the relative moving distance. The result indicates that air-based EWOD faces challenges when actuating biological fluids. When silicone oil environment is introduced to EWOD, the actuation of three body fluids gets improved to varying degrees. However, all three body fluids experience droplet fragmentation during actuation due to the high viscous resistance induced by the oil environment, which prevents subsequent continuous actuation [91]. In contrast, EPD can actuate them smoothly without changing any of the parameter settings, showing EPD's compatibility with body fluids.

Besides, these experiments show that EPD also exhibits overwhelming collective performances in terms of compatibility with substrates and surroundings (air/oil/air-oil interface), actuation speed (up to 60 mm/s), working voltage (5.5V), cost of fabrication (lower than US$1 for consumables and ˜US$100 for control system), etc. (FIG. 2D, TABLE 1). These superior properties endow the proposed EPD-based droplet robotic system with the potential to enhance liquid-based scientific experiments in multiple fields, such as clinical, biological, and engineering sciences. By demonstrating lithium monitoring in multiple body fluids as an example, the potential of the proposed EPD-based Multiphysics droplet robotic system can be shown to assisting biochemical experiments, promoting the application of robots in basic science.

FIG. 2A shows the working principle of the EPD-based droplet actuation. FIG. 2B is an optical image of the EPD-based multi-physics droplet robotic system and its core components. In FIG. 2C there are shown overlaid sequential images (derived from video frames), which visualize the moving path of the droplet actuated by the EPD-based Multiphysics droplet robotic system, including the shape of “H”, “K”, “U”, respectively. The scale bar in FIG. 2C is 10 mm. In FIG. 2D to the right there is a comparison between the proposed EPD-based droplet robotic system of the present invention and the existing automated droplet robotic system from 6 perspectives shown on the left. The operable liquid types and the compatibility with bio-sample are particularly demonstrated and compared with EWOD on the right in FIG. 2D. The evaluations are conducted based on the detailed information in TABLE 1. EPD's wide range of operable liquid types and the compatibility with bio-sample are particularly demonstrated and compared with air-based EWOD and oil-based EWOD based on FIGS. 3A-3F.

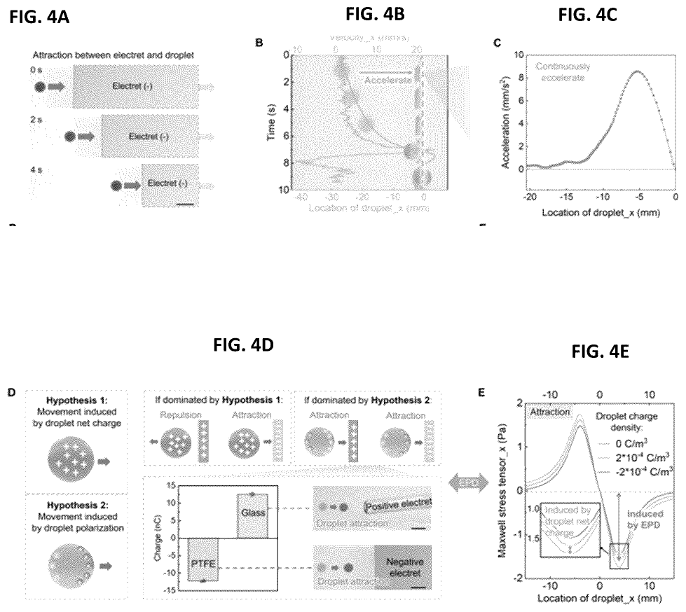

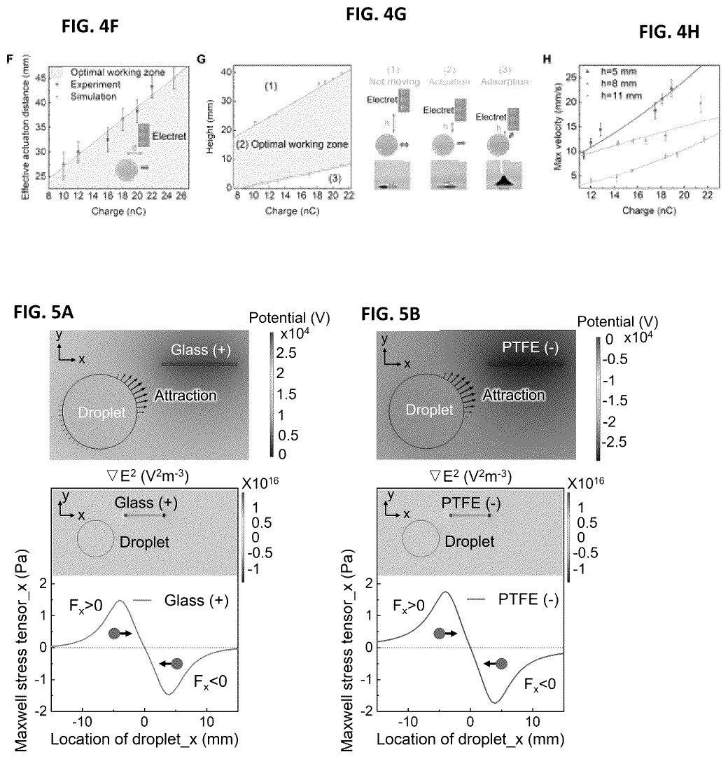

The present invention builds upon a newly observed attraction effect between various liquid droplets and the intrinsically charged electret (FIG. 4A). When a water droplet is placed at a position ˜30 mm away from the negatively charged electret, it is attracted towards the electret with a positive acceleration (FIGS. 4B and 4C) and reverses its direction once it reaches the position below the edge of electret. The mechanism of droplet actuation caused by electret with intrinsic charges can be explained by two potential hypotheses: 1. droplet net charge-induced movement and 2. droplet polarization-induced movement (FIG. 4D). In the first hypothesis, due to the contact electrification with other solid surface/immiscible liquids, droplets will tend to obtain electrostatic charges of a certain polarity (usually positive for deionized water) [47, 48]. Therefore, the electrostatic field formed by the electret may exert an attractive/repulsive Coulomb force on the charged droplet [49, 50]. In the second hypothesis, since the electret will generate a nonuniform electrostatic field, the droplets will be polarized into dipoles. This is termed electret-induced polarization on droplet (IPD). Based on the difference in polarizability between the droplets and the surrounding medium, the polarized droplets will move towards/against the direction of the electric field maxima [51, 52]. Compared with the traditional “AC/DC electric field-induced” polarization [51,52], EPD employs the electrostatic charges carried by the electret, eliminating the effect of conduction current and thus leading to different variables and application scenarios.

As indicated, FIG. 4A is an optical image of the electret-induced actuation of a droplet floating on oil surface and two potential hypotheses to explain the phenomenon. The scale bar is 5 mm. FIG. 4B shows actuation of the droplet by two electrets carrying opposite charge polarities to investigate the dominating hypothesis. Again, the scale bar is 5 mm. Similarly, FIG. 4C shows acceleration of the droplet during its attraction by a fixed electret. It is a simulation of the droplet carrying a measured amount of positive charge (2×10⁻⁴ C/m³) attracted by both a positive electret and a negative electret. Arrows in the figure represent the Maxwell stress tensor applied to the droplet. Further, FIG. 4D is used to demonstrate two potential hypotheses explaining the observed attraction between the electret and droplet (left), while the dominating hypothesis can be determined by actuating droplets with two electrets carrying opposite charge polarities (right). The scale bar is 5 mm and the Error bars, SD (n=3). Thus, FIG. 5D shows a simulation of the average Maxwell surface stress tensor applied to the droplets with positive, negative, and neutral charge densities, quantifying the effect induced by droplet net charge (red arrow) and EPD (green arrow). An electret sheet is located at 0 mm with a width of 6 mm and a height of 0.2 mm. The direction of the Maxwell stress tensor is the same as the direction of the location coordinates. FIG. 4E shows the results of simulations of the average Maxwell surface stress tensor applied on droplets with positive, negative, and neutral charge densities, while the set value is determined by the practically measured droplet charge amount [47]. The results indicate that the force induced by EPD effect (green arrow) is much larger than that induced by droplet net charge (red arrow). FIG. 4F shows the relationship between the effective actuation distance of the droplet and the absolute charge amount of the electret, including both experimental results (blue dot) and simulation results (yellow dot). Error bars, SD

FIG. 4G shows phase diagrams of the droplet dynamic behaviors achieved by adjusting the electret's charge amount and the height difference between the electret and droplet. including (1) the droplet staying stationary (green region), (2) the normal lateral actuation, which is also the optimal working zone (blue region), and (3) the adsorption on the electret (yellow region). The blue line and yellow line represent the maximum and minimum height difference required for effective actuation. Error bars, SD (n=3). Scale bar: 2 mm. FIG. 4H shows the relationship between the maximum actuation velocity of a 10 μL droplet and the absolute amount of charge under different height differences. Error bars, SD (n=3).

In practical situations, force induced by the droplet net charge and droplet polarization may coexist, which can be described as described above. [53, 54]

$$\begin{matrix}F = \int ρ E \cdot dV + 4 {πε}_{m} {r}^{3} \frac{{ε}_{d} - {ε}_{m}}{{ε}_{d} + 2 {ε}_{m}} ( E \cdot ∇ ) E \\ = \int \int ρ \frac{φ dS}{4 {πε}_{m} {d}^{2}} dV + 4 π {ε}_{m} {r}^{3} \frac{{ε}_{d} - {ε}_{m}}{{ε}_{d} + 2 {ε}_{m}} ( \int \frac{φ dS}{4 π {ε}_{m} {d}^{2}} \cdot ∇ ) \int \frac{φ dS}{4 {πε}_{m} {d}^{2}}\end{matrix} \qquad ( 1 )$$

where the first item is induced by droplet net charge, while the second item is induced by polarization, i.e., EPD. ρ is the volumetric charge density of the droplet, φ is the surface charge density of the electret, r is the radius of the droplet and is assumed much smaller than the scale of the filed nonuniformity [54], d is the distance between the electret and droplet, εₘ and ε_{d} are the permittivity of the surrounding medium and droplet, respectively. To validate which hypothesis dominates in the droplet actuation process, two electrets carrying opposite charge polarities are utilized to actuate the same water droplet floating on the HFE oil surface (FIG. 4D). According to the experimental results in FIG. 5D, consistent with the simulation results in FIGS. 5A and 5B, water droplets are attracted by both positively charged and negatively charged electret. This result proves that the direction of the generated force F will not change with the polarity of P (Equation 1). Therefore, the force induced by EPD is much larger than that induced by droplet net charge, indicating the dominance of EPD effect in the system of the present invention. The simulated results of the Maxwell stress tensor applied on droplets with positive, negative, and neutral charge densities further support this conclusion that the EPD effect dominates, while the force induced by droplet net charge only accounts for about 8% (FIG. 5E).

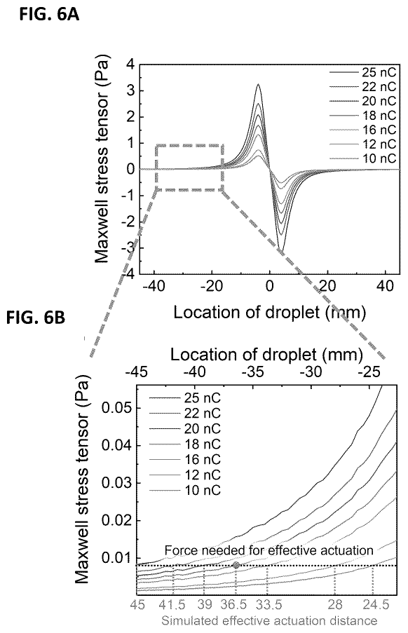

To achieve the well-controlled EPD-based droplet actuation, the lateral distance between the electret and droplet should be less than the effective actuation distance, as measured and simulated in the FIG. 5F (FIGS. 6A and 6B). Similarly, the vertical distance between the electret and the droplet also needs to fit within an appropriate interval (FIG. 4G). If the height of the electret is too high or the charge density of the electret is too low, the EPD force will be smaller than the lateral resistance, and the droplet will remain stationary. Vice versa, the excessive EPD force will cause the absorption of the droplet, resulting in a failed actuation. Within the optimal working state (state 2 in FIG. 4G), the droplet can be actuated horizontally, while the maximum actuation velocity can be enhanced by increasing the charge amount of electret or decreasing the height difference between electret and droplet (FIG. 4H).

The droplet actuated by EPD should be subjected to two forces, one is the driving force generated by EPD effect, F_{EPD}, and the other is the drag force on the droplet as it moves through the oil layer, f. According to Equation 1 and Stokes Law, we have:

$${F}_{EPD} ∝ {φ}^{3} and f = 6 πη rv$$

where r is the radius of the droplet and is assumed much smaller than the scale of the field nonuniformity¹, η is the viscosity of the oil layer, v is the speed of the droplet.
Therefore, when the droplet accelerates to the maximum velocity, we should have:

$$a = \frac{{F}_{EPD} - f}{m} - 0$$

which lead to:

$${F}_{EPD} = f$$

As a result, we can have:

v∝φ²

Based on these empirical relationships, the optimal working zone of the system can be determined, including electret's lateral position, vertical position, carried charge amount, and moving speed, laying a foundation for further automated droplet actuation systems.

Water droplets will carry positive charges after contact with HFE [(47)]. Therefore, if the first net charge-based hypothesis dominates, i.e., the first item in Equation 1 dominates, the droplets will be repelled by the positively charged electret and attracted by the negatively charged electret since the polarity of the generated force changes with φ. Conversely, if the second droplet polarization-based hypothesis dominates, regardless of the polarity of φ, the droplet will always move towards the electret, i.e., the electric field strength is maximum when ε_{d} is bigger than εₘ. The results in FIG. 4B show that the water droplets always move towards the local electric field maxima (the edge of the electret) regardless of the electret polarity, which is consistent with the case of hypothesis 2, suggesting that the EPD dominates.

This inference can be further supported by the simulation results which take the practical charge amount of the droplet into consideration. The result shows that the force exerted on the droplet carrying a measured amount of positive charge (2×10⁻⁴ C/m³) is always directed toward the electret, including both positive and negative electrets (FIGS. 5A & B). Therefore, the droplet should be attracted by both positive and negative electrets, consistent with the experimental results. To quantify the effect of droplet net charge in this system, the x component of the Maxwell surface stress tensor applied on droplets with positive, negative, and neutral charge densities (FIG. 4D) were simulated and calculated. According to Equation 1, the force applied on the uncharged droplet (ρ=0) should be induced by EPD only. Accordingly, the part that varies with the droplet's charge density ρ should be induced by droplet net charge. Based on the simulation results, the force induced by the droplet net charge only accounts for about 8% of the EPD force, proving the dominance of the EPD effect. The simulated Maxwell stress tensor is also compared with the measured droplet's acceleration while attracted by an electret (FIGS. 4E and 4F). The simulated stress and the experimentally measured acceleration show a similar variation trend of increasing and then decreasing as the droplet approaches the electret, demonstrating the consistency of the experiment and simulation.

Based on the understanding of EPD mechanism, this effect can be utilized to build an automated droplet actuation system. Therefore, the effect of the electret's charge amount and relative position on droplet actuation needs to be further explored in order to find the optimal working zone. The effective actuation distance is first measured and simulated to find the lateral threshold of the comfort zone. The effective actuation distance exhibits a positive linear correlation with the charge amount carried by the electret, which is generally consistent with the simulation results (FIG. 4G, FIGS. 6A and 6B). Therefore, to achieve effective actuation, the lateral distance between the electret and the droplet should be less than the effective actuation distance as shown in FIG. 4G. Similarly, the vertical distance between the electret and the droplet is also adjusted and investigated. Three different scenarios of droplet dynamic behaviors can be observed with varying height and charge amount of the electret (FIG. 4H). In the first scenario, when the EPD force is relatively smaller than the lateral resistance, the droplet will remain stationary. With an increasing charge amount of electret or decreasing height difference, the droplet can be actuated horizontally to move towards the electret. To achieve the optimal working state, the charge of the electret and the height difference with the droplet should fit within this interval. As the charge amount continues to increase or the height difference continues to decrease, the excessive EPD force will cause the absorption of the droplet to the electret, resulting in a failed actuation.

In the optimal working zone, the maximum velocity of the droplet actuation is also investigated. The max velocity has been proven to increase linearly with the amount of charge, while a decrease in the height difference between the electret and the droplet can further increase the maximum droplet movement velocity up to 23 mm/s (FIG. 4H). Based on the explored relationships, the optimal working zone of the system can be determined, including the electret's lateral position, vertical position, carried charge amount, and moving speed, building a foundation for further automated droplet actuation systems.

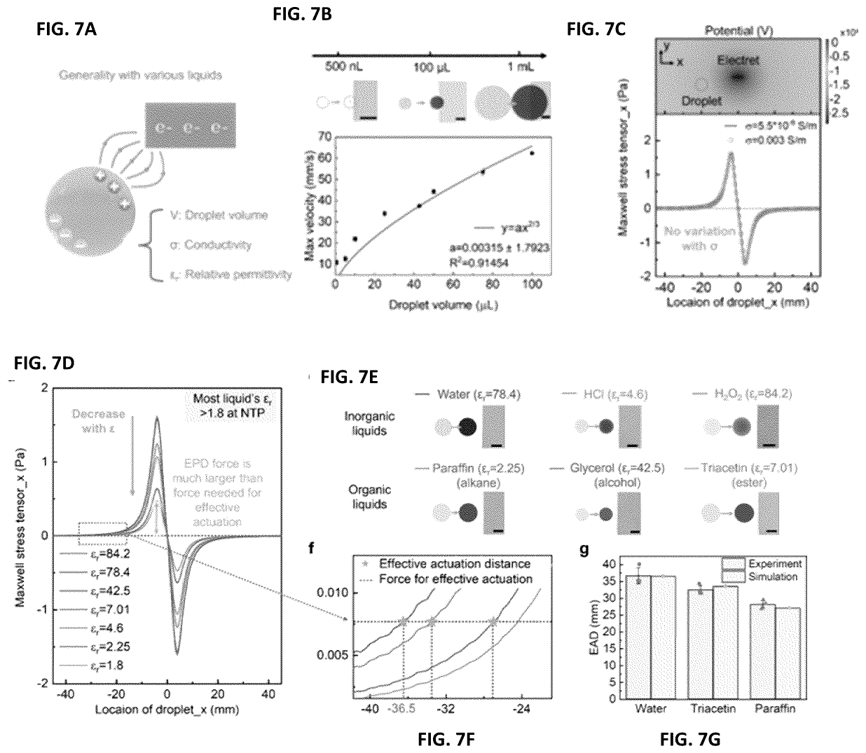

In contrast to EWOD's limitations on droplet volume (usually nL-μL, depending on electrode size) and liquid types (usually only for conductive and aqueous liquids) [35], EPD shows advantages in generality for various liquids, including a wider range of droplet volume, liquid conductivity, and liquid permittivity (FIG. 7A-7G). FIG. 7B demonstrates the actuation of droplets with volumes ranging from nanoliters to milliliters under EPD effect, including a broad volume range up to four orders of magnitude. As the droplet volume increases, the maximum velocity of droplet movement also increases from 22 mm/s (10 μL) to 60 mm/s (100 μL), comparable with other common droplet actuation techniques (TABLE).

The droplet actuated by EPD should be subjected to two forces, one is the driving force generated by EPD effect, F_{EPD}, and the other is the drag force on the droplet as it moves through the oil layer, f.

### According to Equation 1 and Stokes Law:

$${F}_{EPF} ∝ V ∝ {r}^{3}$$

$$and$$

$$f = 6 πη rv ∝ r$$

where V is the volume of the droplet, r is the radius of the droplet and is assumed much smaller than the scale of the field nonuniformity¹, η is the viscosity of the oil layer, v is the speed of the droplet.

Therefore, the acceleration of the droplet a can be described as:

$$a = \frac{{F}_{EPD} - f}{m}$$

where m is the mass of the droplet.

Therefore, when the droplet accelerates to the maximum velocity,

a=0

which leads to:

$${F}_{EPD} = f$$

As a result:

$$v ∝ \frac{{r}^{2}}{r} = {r}^{2} ∝ {V}^{\frac{2}{3}}$$

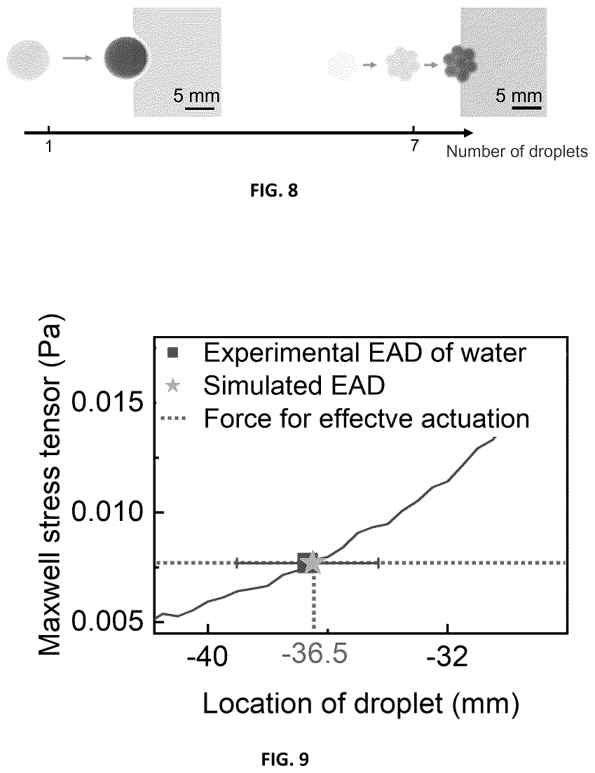

In addition to the droplet volume and different numbers of droplets can also be actuated simultaneously by EPD as shown in FIG. 8, in which an illustration of the EPD-based actuation of multiple droplets, i.e., 1 droplet and 7 droplets, can both be actuated by the electret. In that illustration a surface surfactant is introduced into the oil substrate when actuating multiple droplets to prevent the droplets from merging. Thus, multiple droplets can also be actuated simultaneously by EPD as shown in FIG. 8.

FIG. 7A is a schematic diagram of EPD's generality with various liquids. FIG. 7B shows EPD-based actuation of droplets with volumes ranging from nanoliters to milliliters. The max actuation velocity increases with droplet volume under a two-thirds power relationship. The scale bar: 5 mm. FIG. 7C shows a simulated Maxwell stress tensor applied to droplets with different conductivities, showing that the generated EPD force on droplet does not change with conductivity. The electret sheet is located at 0 mm with the width of 6 mm and height of 0.2 mm. The direction of the Maxwell stress tensor is the same as the location coordinate. FIG. 7D shows a simulated Maxwell stress tensor applied to droplets with different relative permittivity (solid lines). The calculated Maxwell stress tensor for the liquid with minimum relative permittivity of 1.8 at NTP (purple line) is still much larger than the minimum force required for effective actuation (blue dash line), thus indicating that EPD has the potential to manipulate all types of liquids. FIG. 7E shows optical images of EPD-based droplet actuation, including three common inorganic liquids as well as three common organic liquids, including alkane, alcohol, and ester. The scale bar is 5 mm. In FIG. 7F there is illustrated a simulated effective actuation distance of water, triacetin and paraffin (star symbol) obtained from a crossing between the calculated Maxwell stress tensor (solid line) and the minimum force required for effective actuation (dash line), while FIG. 7G shows a comparison between the simulated and the measured effective actuation distance (EAD), with no significant difference shown (One sample t-test, P>0.05), demonstrating the validity of the simulation result. Error bars, SD (n=3).

In terms of liquids with different conductivity, the Maxwell stress tensor generated by EPD is simulated and calculated (FIG. 7C). The results show that the EPD force on the droplet does not change with conductivity, consistent with the mechanism by which EPD uses electrostatic charges to polarize droplets without generating conduction current as discussed above. Therefore, for the EPD-based droplet actuation, the range of liquids can extend the operable range of liquids from conductive to dielectric liquids. For liquids with different relative permittivity, the simulation results show that the force generated by EPD decreases as the permittivity decreases (FIG. 7D). However, the generated EPD force for liquid with the minimum relative permittivity of 1.8 (at normal temperature and pressure [56]) is still much larger than the minimum force required for effective actuation (blue dash line in FIG. 7D. The value of the dash line is obtained based on the measured maximum effective actuation distance of water droplet, as shown in FIG. 9), thus indicating that EPD has the potential to manipulate all types of liquids. In FIG. 9 a water droplet's effective actuation distance (EAD) is first measured (black square). Then, based on the crossing of the measured EAD of water and the simulated Maxwell stress tensor applied to the water droplet, the force needed for effective actuation (dash line) is determined.

To verify EPD's generality of operable liquid types, i.e., its adaptability to a wide range of operable liquid types, three common inorganic liquids as well as three common organic liquids, with relative permittivity ranging from 2.25 to 84.2, including alkane, alcohol, and ester, were selected for the experiments (FIG. 7E). The experimental results show that EPD can smoothly actuate various inorganic/organic liquids without changing any parameter setting, since the generated EPD force, even for low permittivity liquid, is strong enough to overcome the moving resistance (FIG. 7D & 7F). In contrast, EWOD is inadequate for manipulating organic liquids with low permittivity due to the limitation of the electrowetting mechanism, either in the surrounding of air or oil (FIG. 3A-3C. In addition, the simulated effective actuation distances of different droplets can also be obtained from the crossing between the calculated Maxwell stress tensor and the minimum force required for effective actuation (FIG. 7F). The result shows that the effective actuation distance of droplets decreases with the permittivity of the droplet, and the calculated results match with the experimental results with no significant difference, as shown in FIG. 7G. Based on both simulation and experiment results, the EPD effect exhibits a superior generality with a wider range of operable liquids, showing the potential for all-liquid handling.

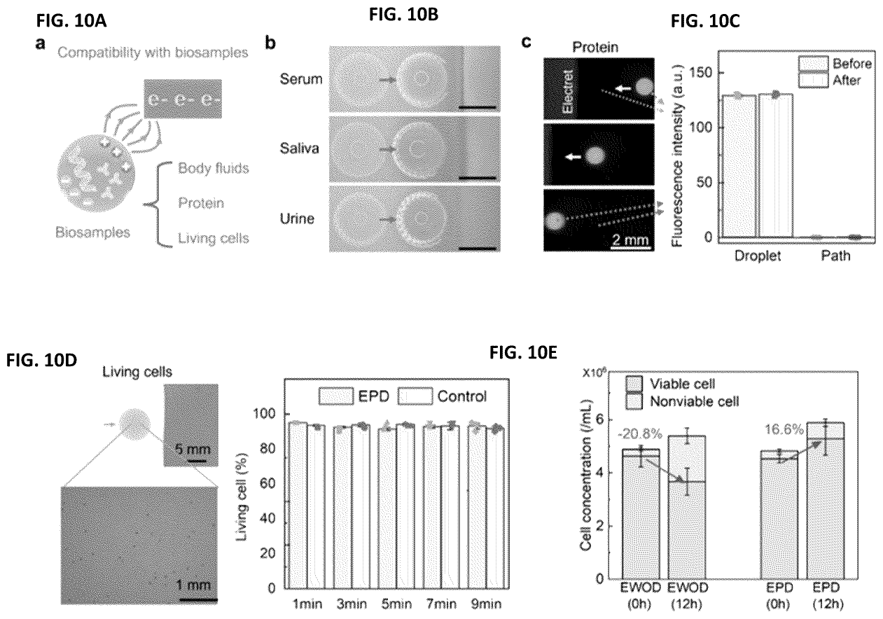

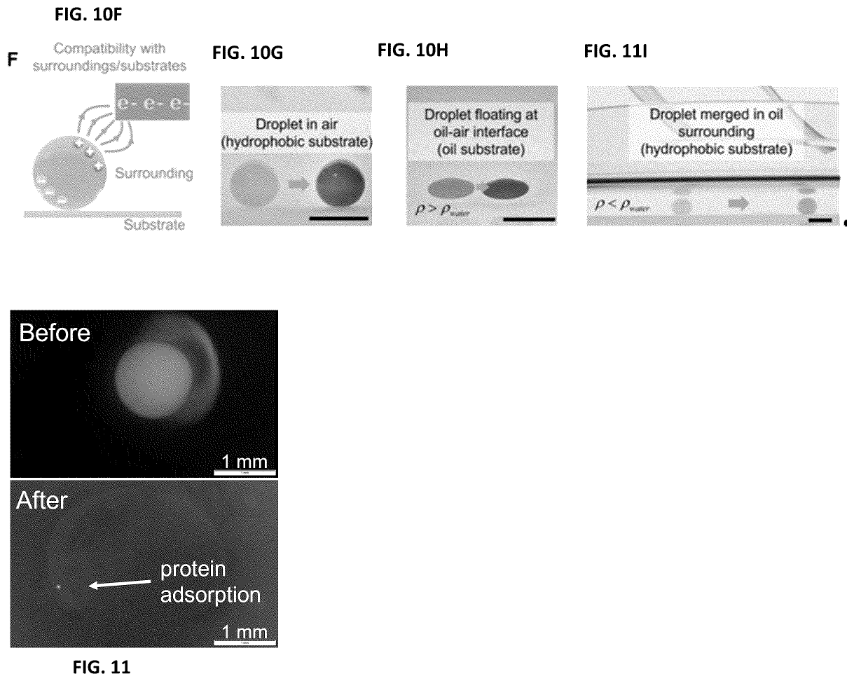

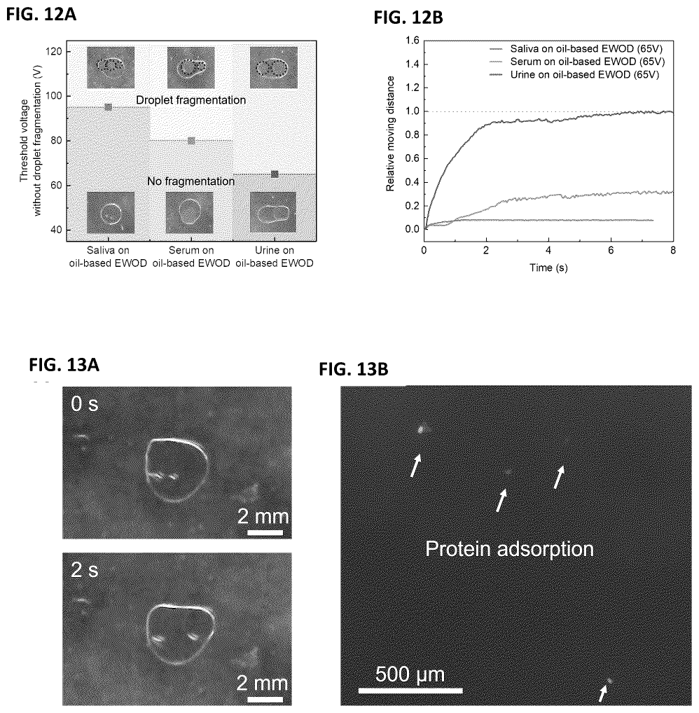

Considering that droplet robots are often employed to carry bio-samples [69], some evaluations of the biocompatibility of EPD-based droplet actuation were also conducted. This evaluation encompassed a range of bio-samples, including body fluids, proteins, and living cells (FIG. 10A). As for body fluids, human serum, saliva, and urine is tested, and EPD can successfully actuate different body fluids without requiring any modification (FIG. 10B). However, when manipulating these body fluids on a common double-plate EWOD, droplet actuation becomes challenging, and the moveable distance varies among different body fluids (FIG. 3A & 3B, FIG. 12A & 12B). The different performances when actuating various body fluids between EPD and EWOD may be attributed to two reasons, one of which is the wide variation in electrical conductivity of different body fluids, affecting the setting of working voltage and actuation robustness of EWOD [57, 58]. On the contrary, EPD has proved to be independent of liquid conductivity (FIG. 7C). The other reason is that proteins in the body fluids appear to be significantly adsorbed on the substrate of EWOD, especially on the air-based EWOD (FIG. 11 and FIG. 13A & 13B) Due to electrostatic interactions with the charged electrode and hydrophobic interactions with the surface that hinder the droplet movement on EWOD (FIG. 11) [37-39]. In particular, FIG. 11 shows photos under a fluorescence microscope illustrating the protein adsorption on double-plate EWOD after actuating a droplet of 0.01% BSA solution. Although the introduction of certain additives (e.g. Pluronics) may partially release the protein adsorption issue in EWOD, it still cannot fundamentally solve the problem since additives may be potentially cytotoxic and the species as well as the concentration of the surfactants need to be customized according to the operated protein solution. However, on the contrary when actuating droplets containing fluorescent proteins in EPD, no significant changes in fluorescence intensity are observed either on the trajectory of the droplet or inside the droplet before and after droplet movement (P>0.05) (FIG. 10C). This result indicates that EPD-based droplet actuation will not cause observable protein residues, minimizing the risk of biofouling.

As noted, FIG. 10A is a schematic diagram of EPD's compatibility with bio-samples, including body fluids, protein, and living cells. In FIG. 10B optical images showing the EPD-based actuation of body fluids, including human serum, saliva, and urine are presented. The scale bar is 3 mm. FIG. 10C shows serial photos under fluorescence microscope illustrating the EPD-based actuation of fluorescent protein solution. The fluorescence intensity on the trajectory of the droplet or inside the droplet before and after droplet movement shows no significant difference (paired t-test, P>0.05), demonstrating that no protein residue can be observed in the EPD-based droplet actuation. Error bars, SD (n=4). In FIG. 10D EPD-based actuation of living A549 cells within culture medium are shown, where the percentage of living cells is analyzed and compared with the control group in air. Error bars, SD (n=3). Thus, living cells can also be actuated under the effect of EPD. FIG. 10E shows variations of viable and nonviable cell concentrations after being treated on EPD/EWOD for 30 mins and then incubated for 12 hours, demonstrating cell-related biocompatibility of EPD. Error bars, SD (n=3). A schematic diagram of EPD's compatibility with various surroundings and substrates is shown in FIG. 10F, while FIG. 10G shows optical images illustrating the EPD-based droplet actuation in air on a hydrophobic surface. The scale bar is 3 mm. FIG. 10H has optical images showing the EPD-based actuation of droplets floating on an oil surface, where the max actuation velocity can be adjusted by introducing surface surfactant. The scale bar is 3 mm. FIG. 10I shows optical images of the EPD-based actuation of droplet merged in an oil surrounding, with a hydrophobic substrate. Scale bar: 3 mm.

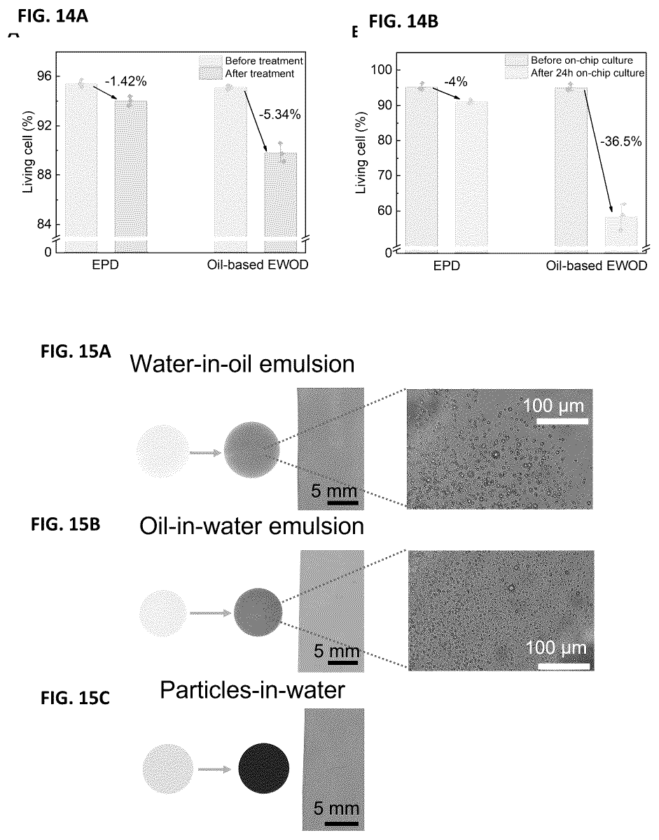

Besides body fluids and protein solutions, the effect of EPD on cell activity is also investigated (FIG. 10D). Compared to the control group in air, the percentage of living cells does not change significantly during the actuation process, demonstrating that EPD can maintain the viability of living cells during actuation. In addition to cell activity, the effect of EPD on proliferation capacity of cells is also verified. Cells treated by EPD show a significant proliferation after 12-hour incubation, while the concentration of living cells among them increases by 16.6% (FIG. 10E). In contrast, the number of living cells treated by the air-based EWOD decreased by 20.8% after incubating for 12 hours. Similar negative effects on living cells are also observed in oil-based EWOD (FIGS. 14A and 14B).

In FIG. 14A the impact of EPD and electrowetting effect on cell activity is indicated by the variation of the percentage of living cells after being treated by EPD/oil-based EWOD for 30 mins and then incubated for 12 hours. The activity of cells treated by oil-based EWOD decreases with a higher degree than that of cells treated by EPD, suggesting that the introduction of oil environment still could not completely avoid the effect of Joule heating and high electric field strength on cell activity. Error bars, SD (n=3). In FIG. 14B the impact of EPD and oil-based EWOD system setup on cell culture are indicated by the variation of the percentage of living cells after being cultured for 24 hours on EPD/oil-based EWOD without power supply. The percentage of living cells cultured on the oil-based EWOD (58.5%) is significantly lower than that of cells cultured on the EPD (91.2%). This is likely because the silicone oil environment on the double-plate EWOD limits the gas exchange between the droplet and the atmosphere, thus leading to asphyxiation of the cells within the droplet. Error bars, SD (n=3).

These negative effects of EWOD on living cells may be caused by Joule heating and high electric field strength in the electrowetting effect [44,45], which are eliminated in the electrostatic charges-based EPD. Therefore, compared with either air-based or oil-based EWOD, EPD shows better compatibility with living cells. This indicates that living cells can maintain good proliferation capacity after EPD treatment compared to EWOD, further demonstrating the biocompatibility of EPD. In addition to bio-samples, EPD-based droplet actuation is still feasible when the droplet contains other chemical samples, such as oil-in-water emulsions, water-in-oil emulsions, or nanoparticles-in-water (FIGS. 15A-15C). FIG. 15A shows optical images of EPD-based actuation of 10% water-in-oil emulsion, while the optical image on the right side of this figure shows the inside of the emulsion. FIG. 15B shows optical images of EPD-based actuation of 10% oil-in-water emulsion, while the optical image on the right side of this shows the inside of the emulsion. FIG. 15C shows optical images of EPD-based actuation of particles-in-water (iron oxide magnetic nanoparticles, 30 nm).

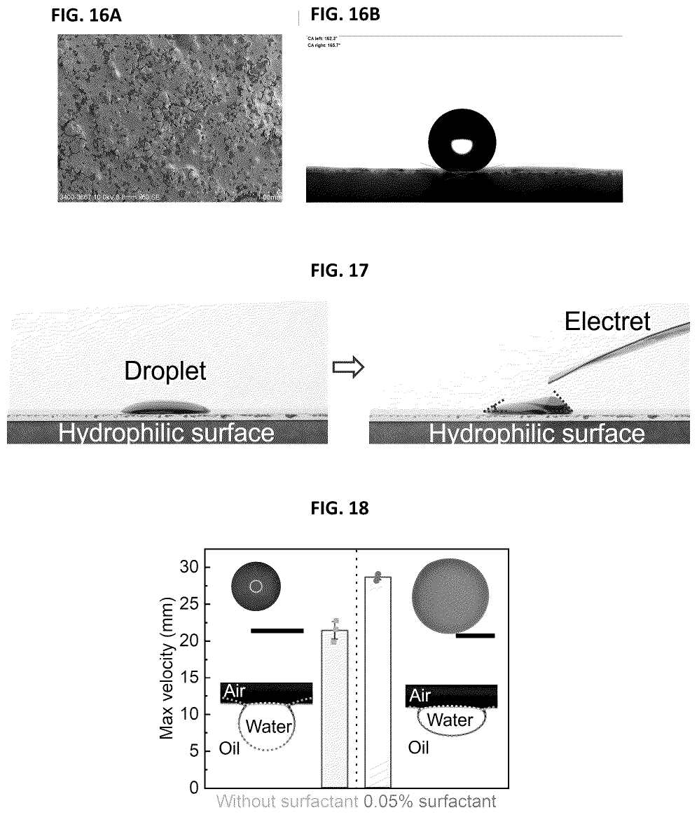

The compatibility of EPD-based droplet actuation with various surroundings and substrates is also demonstrated (FIG. 10F). Droplets in the surroundings of air (FIG. 10G), oil-air interface (FIG. 10H), and oil (FIG. 10I) can all be actuated by EPD, as long as the permittivity of the droplet is different from that of the surrounding medium (Equation 1). As for the substrate, unlike EWOD [84,85], EPD has no requirements for substrate material or thickness, but it still requires a hydrophobic surface (FIG. 16A & 16B) or oil-substrate to reduce the actuation resistance and droplet residue. The actuation on hydrophilic surfaces would be limited by the increasing resistance (FIG. 17). In FIG. 17 an EPD-based droplet actuation on hydrophilic surface exhibits a tendency to move with different contact angles on advancing and receding sides. Compared with the hydrophobic surface, the increasing resistance on the hydrophilic surface leads to the failure in droplet actuation. The contact angle hysteresis of droplets on hydrophilic surfaces significantly grows larger than those on hydrophobic surface [12], while the contact area of the droplets also increases, thus leading to a substantially larger relative friction force [14,15]:

$$F = w γ ( cos {θ}_{r} - cos {θ}_{a} )$$

where w is width of the droplet bottom perpendicular to the direct of the motion, γ is surface tension at liquid-air interface, cos θ_{d}, and cos θ, are advancing and receding contact angles of the liquid-solid interface. Compared to a superhydrophobic surface (in the case of θₐ=160° and θᵣ=150°)¹⁶, the resistance of a hydrophilic surface (in the case of θₐ=58° and θᵣ=12°)¹² can theoretically increase more than 40 times.

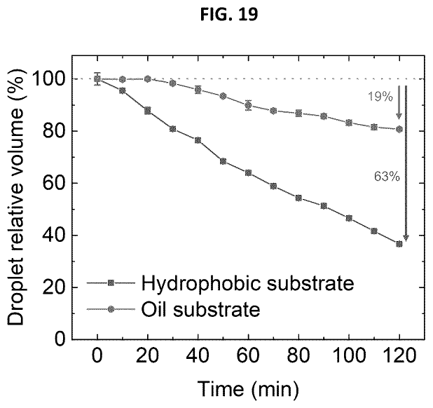

When oil substrate is utilized, the maximum actuation velocity can be further adjusted by introducing surfactant (FIG. 18). The change of droplet shape from an approximate sphere to an ellipsoid may be the main reason for the increasing velocity [60,86]. Considering that droplet evaporation on the oil substrate is only 30% of that on the hydrophobic substrate (FIG. 19), further following quantitative experiments were all conducted by manipulating droplets floating on the oil-air interface instead of the hydrophobic substrate.

The data for the graphs of FIG. 19 is obtained when water droplets of 15 μL are dropped on a superhydrophobic substrate with contact angle of 163° and an HFE oil surface, which are placed on an open benchtop. Room temperature and humidity levels are kept constant during the test period. A camera photographs the droplets from above at 10-minute intervals. The dimensions of the droplets are analyzed using ImageJ and the volume change of the droplets is calculated. The results show that droplet evaporation on the oil substrate (red line) is only 30% of that on the hydrophobic substrate (blue line) in two hours at room temperature.

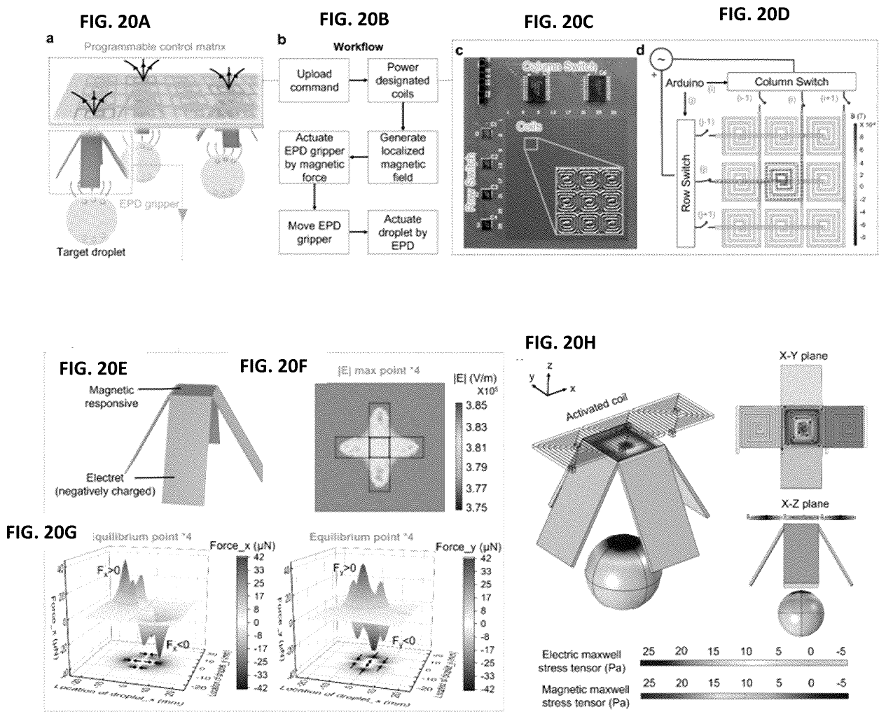

To further exploit the EPD effect for automated liquid manipulation, a Multiphysics droplet robotics system is proposed as shown in FIGS. 20A-20H and FIG. 2B. As noted above, the system consists of three basic parts, 1) a Printed Circuit Board (PCB) control matrix which can be programmed to generate localized magnetic fields by exciting specific coils; 2) a EPD gripper made of magnetic responsive material and electret composites, which can be shifted by the magnetic field generated by the control matrix and simultaneously induce a mobile non-uniform electrostatic field to attract the droplet below; and 3) a target liquid droplet that can be polarized. When performing automated droplet movement or actuation with this system, commands need to be uploaded to the control board first to power the designated coils in a control matrix and to generate a localized electromagnetic field (FIG. 20B). Then, the EPD gripper nearby will be actuated by magnetic force and moved to the designated location. The shifted gripper subsequently attracts droplets via EPD so that the droplet can move along with it. By repeating this process, multiple EPD grippers can work collaboratively to actuate multiple droplets step-by-step to the target location.

In FIG. 20A there is shown a schematic diagram of the proposed Multiphysics droplet robotic system and the general workflow of the proposed Multiphysics droplet robotic system is shown in FIG. 20B. FIG. 20C is a photograph of the programmable control matrix fabricated on a multilayer PCB, composed of row switches, column switches, an electromagnetic coil matrix and a signal/power socket. FIG. 20D is the operational schematic of the control matrix and corresponding simulation result, which shows the distribution of the magnetic field when the coil is powered at the coordinate of (j,i). FIG. 20E is a schematic diagram of the EPD gripper, which consists of magnetic responsive material and electret composites. The simulated electric field strength of the EPD gripper is shown in FIG. 20F (bottom view), in which four local maxima of the electric field are present. FIG. 20G shows the force generated by the EPD gripper in the x direction (left) and the y direction (right) on the droplet at different locations, with four force stable equilibrium points labeled with arrows. The direction of the force in the X and Y directions is consistent with the direction of the X and Y coordinates, respectively. FIG. 20 H shows a simulated magnetic Maxwell stress tensor on the EPD gripper and an electric Maxwell stress tensor on the target droplet. Arrows represent the direction of current in coils.

In the programmable control matrix, electromagnetic coils are fabricated on a multilayer PCB and are controlled by two integrated switches for row and column selection (FIG. 20C). By activating row and column switches corresponding to the specified coordinates, direct current will flow through the designated coils and generate a localized magnetic field (FIG. 20D). From the magnetic field simulation results, the strength of the generated vertical magnetic field is concentrated within the range of the specified coils. Therefore, it can accurately drive the magnetic responsive EPD grippers located near the specified coordinates, without affecting those at longer distances, providing a foundation for multi-grippers synergistic cooperation. Compared with employing robotic arms to actuate EPD grippers, the approach of generating a controllable magnetic field with PCB not only reduces the fabrication cost of the system, but also offers the potential for spatial crossover manipulation to process multiple droplets in parallel.

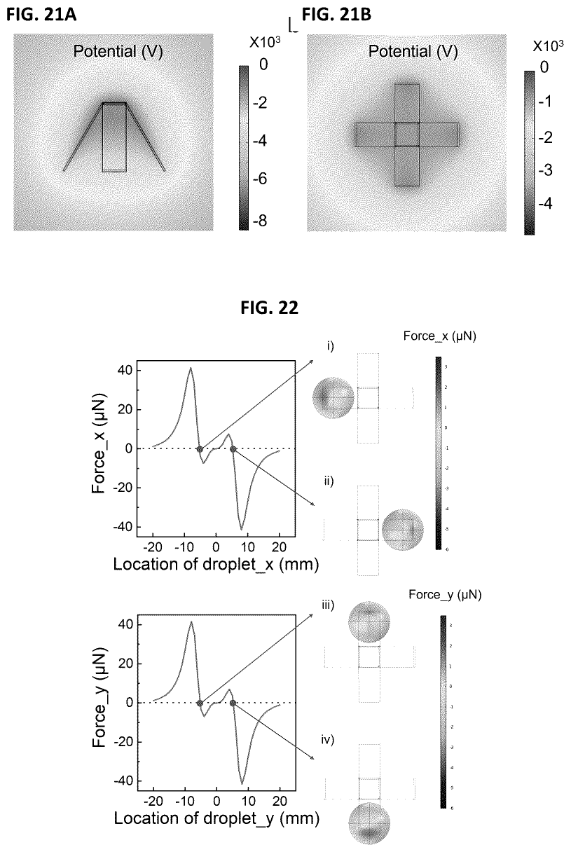

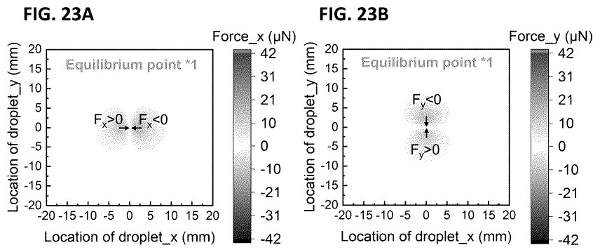

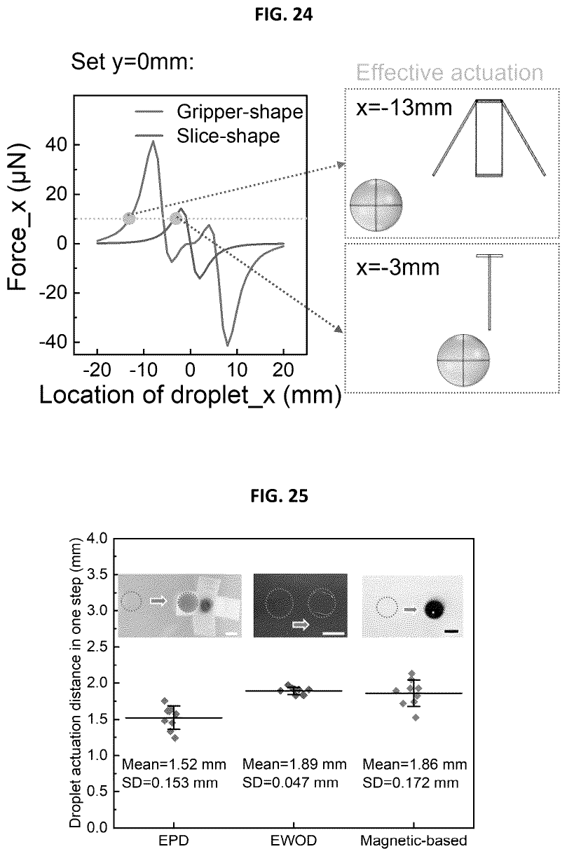

As for the EPD gripper, magnetic responsive material and electret composites are utilized. The magnetic responsive section on the top can move the entire gripper to the designated coordinates under the magnetic force; while the electret section at the bottom can generate a non-uniform electrostatic field to polarize and attract the target droplet below (FIG. 20E). Different from the slice-shaped electret used in the above characterization set-ups, here the electret section is designed as a gripper shape to increase the number of local maxima of the generated electric field (FIG. 20F). In FIG. 21A there is shown the side view of the simulated electric potential distribution of the EPD gripper and FIG. 21B shows the bottom view of the simulated electric potential distribution. Considering that droplets will move towards the local electric field maxima under EPD effect (Equation 1), such a shape of the gripper will enhance the stability of droplet actuation by providing multiple attraction points. The simulated EPD force applied on the droplet can further support this inference. In FIG. 20G, the arrow-labeled position where the direction of the force switches is the force stable equilibrium point of the droplet, indicating that droplets nearby will tend to be attracted and stabilized at this point. Therefore, droplets nearby will tend to be attracted and stabilized at any of these points (FIG. 22). The generated four force stable equilibrium points in both X and Y directions located at the same positions of the local electric field maxima shown in FIG. 20F, confirms that droplets indeed tend to move toward the four points of local electric field maxima. Compared with the slice-shape electret, which only has one equilibrium point, design of the gripper shape not only improves the stability of droplet actuation, but also increases the force applied on the droplet and the effective actuation distance (FIGS. 23A, FIG. 23B and FIG. 24). FIG. 23A is a simulation of the X component of the force generated by a slice-shape electret that is exerted on the droplet at different locations. The force stable equilibrium points are labeled with arrows. The direction of the force in X direction is consistent with the direction of the X coordinate. FIG. 23B is the Y component of the force exerted on the droplet at different locations, with the force stable equilibrium points labelled with arrows. The direction of the force in Y direction is consistent with the direction of the Y coordinate.

FIG. 24 is a comparison of the force generated by slice-shaped and gripper-shaped electrets on the droplet. The Y coordinate of the droplet is set as 0 mm, and the x component of the force exerted on the droplet is simulated and compared. The yellow dashed line represents the assumed minimum force required for effective actuation. Therefore, the intersection of the dashed line and the force calculated by the simulation (solid line) represents the effective actuation distance (yellow dots). The effective actuation distance of the gripper-shape proved to be larger than that of the slice-shape electret, which means that the gripper-shape electret can actuate droplet at a longer distance, enhancing the ability of self-assembly and capturing/merging of sub droplets. The graphs on the right in FIG. 24 exhibit the force exerted on the droplet at the effective actuation distance by gripper-shape and slice-shape electret, respectively. With the programmable control matrix and EPD gripper of the present invention, the operation of entire system involves Multiphysics field coupling. By converting the electricity into a programmable magnetic field, the control matrix exerts magnetic force on the EPD grippers, while the charge carried by the EPD grippers generates an electrostatic field to actuate or attract the target droplet. The magnetic Maxwell stress tensor and electric Maxwell stress tensor acting in the entire system are shown in FIG. 20H. In the practical scenario, an extra actuation magnet can be used to amplify the electromagnetic field generated by the control matrix, balancing the weight of the EPD gripper, as shown in FIG. 2B.

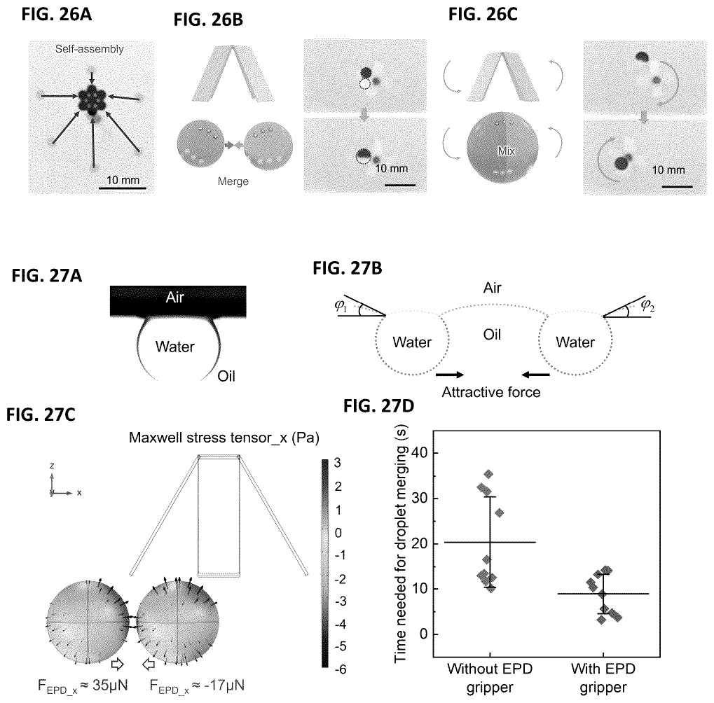

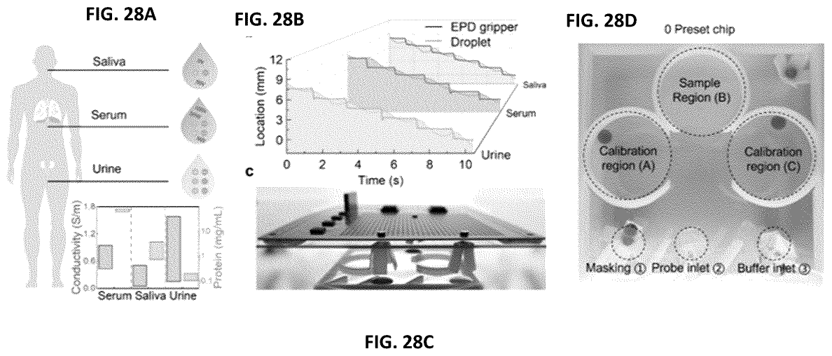

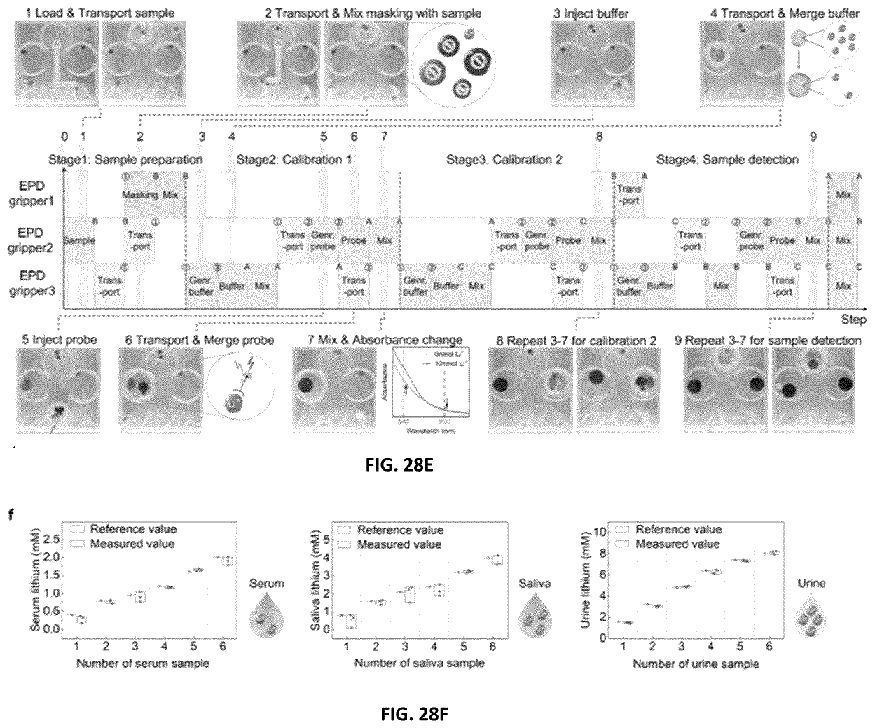

Based on the design principles described above; by programming the control matrix, designated droplet movement can be achieved following different paths, such as the letters “H”, “K” and “U” (FIG. 2C). The actuation resolution is determined by the size of the coil, i.e., ˜1.5 mm in this case, while the actuation precision is related to the movement of the actuation magnet, slightly lower than that of EWOD but comparable with a magnetic-based droplet actuation platform (FIG. 25). In FIG. 26 resolution is defined as the actuation distance in one step, which depends on the coil/electrode/electromagnet size of the platform. In experiments, the resolutions attainable by the three systems are essentially comparable. As for the precision, it is negatively correlated with the standard deviation of actuation distance per step. The results indicate that EWOD has the highest precision, followed by the EPD and magnetic-based systems. Error bars, SD (n=9). Scale bar: 2 mm. Other basic microfluidic functions like self-assembly, merging and mixing of multiple droplets can also be performed in the designed Multiphysics droplet robotic system. The basic microfluidic functions that can be performed by the EPD-based droplet robotic system are shown in FIG. 26A for self-assembly of multiple droplets, FIG. 26B for merging of two droplets and FIG. 26C for mixing of the merged droplets by cyclic motion. Although two droplets floating at the oil-air interface can gradually approach and eventually merge under capillary force [77-81], the presence of an EPD gripper can further accelerate their approach and merging through attractive forces (FIG. 27A-27D).

FIG. 27A is a lateral optical image of the floating water droplet at the oil-air interface. FIG. 27B is a schematic diagram of two floating water droplets at the oil-air interface, showing the distorted interface will lead to the attractive force. FIG. 27C shows a simulated EPD force applied on two droplets by EPD gripper, indicating that both droplets are subjected to EPD forces pointing at each other. FIG. 27D is a plot of the time required for two 20 μL droplets merging, indicating the presence of EPD gripper can help to promote droplet merging.

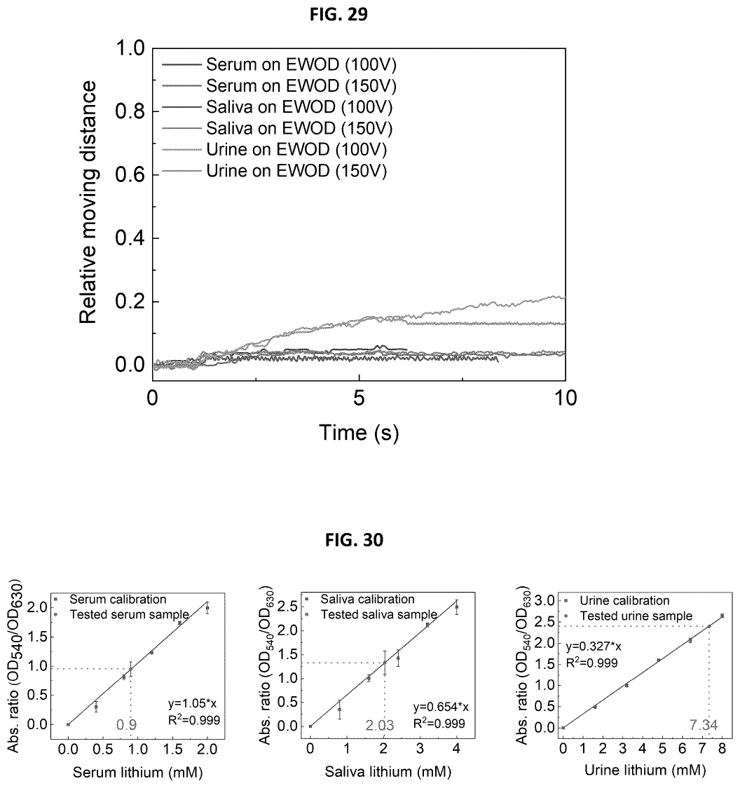

Leveraging the demonstrated EPD's generality for operable liquid species and compatibility with bio-samples, the automated EPD-based droplet robotic system of the present invention has the potential to impact liquid-based scientific experiments in multiple fields. First, the proposed droplet robotics system is applied to automate bioassays for lithium detection in diverse biofluids, as an example, and establish in vitro cell-bacteria models with dynamic monitoring. In the demonstrated applications, six different solutions, living cells, living bacteria, and three kinds of body fluids are manipulated, fully certifying the impact and applicability of EPD in multi-disciplinary scientific research that require precise liquid manipulations. The detection of biomarkers/drugs in multiple biofluids can be used to explore the metabolic relationships among various biofluids, thus contributing to non-invasive drug monitoring and precise medication [82-84]. Thus, the droplet robotics system of the present invention is applied to transform the conventional labor-intensive bioassays into automated bioassays for diverse biofluids. Biomarker detection in multiple biofluids will expediate the process of exploring the concentration relationships of biomarkers across different biofluids, facilitating precision diagnosis and appropriate medication [61]. However, electrical conductivity and protein concentrations differ greatly among different biofluids, such as human saliva, blood, and urine, and fluctuate over a wide range due to individual differences. [62-66]. Nevertheless, the automated lithium drug detection in serum, saliva, and urine can be conducted by the EPD-based Multiphysics droplet robotic system of the present invention. FIG. 29A is a schematic diagram of different body fluids (serum, saliva, and urine), demonstrating that their conductivity and protein concentration vary greatly [62-66]. FIG. 29B shows the characterization of serum, saliva, and urine's actuation on the EPD-based Multiphysics droplet robotic system. The solid line shows the trajectory of the EPD gripper while the dash line shows the trajectory of the actuated biofluids. FIG. 29C is an optical image of the EPD-based droplet robotic system and an auxiliary detection chip, while FIG. 29D is an optical image of the microchip setup, which is designed to conduct two calibrations and one test of a real bio-sample detection as a group. Dyed droplets are used here instead of transparent ones for visualization purposes. FIG. 29E is a step-by-step workflow of the EPD-based droplet robotic system when performing lithium detection, demonstrating the tasks executed by each EPD gripper and their trajectories along with representative screenshots. FIG. 29F shows a comparison between the tested lithium results of serum, saliva, and urine samples with and the reference values, in which the testing values shows no statistically significant difference to reference values (One sample t-test, P>0.05), demonstrating reliability of the bioassay results accomplished on-chip. Error bars, SD (n=3).

For conventional liquid handling techniques such as EWOD, the differences in liquid conductivity among different biofluids will affect the setting of working voltage and actuation robustness [57, 58], while the proteins within will adsorb on the surface due to hydrophobic interaction and electrostatic interaction, resulting in the sample immobilization or cross-contamination [37, 38]. In experiments, most biofluids cannot move smoothly on the tested EWOD platform, while the performance improvement brought by increasing operating voltage (FIG. 30) or introducing oil surrounding (FIGS. 3D-3F & FIG. 13A & 12B) also varies significantly among different biofluids. Therefore, in practical applications, actuation of various biofluids on EWOD needs to either dilute the biofluids [93], remove the protein in it [97], or introduce a certain amount of surfactant [95], while also modifying the voltage and frequency settings [99-101]. However, the common double-plate structure of the EWOD can be applied to manipulate three biofluids (serum, saliva, urine) at 100 V and 150 V (max working voltage), respectively (FIG. 30). In FIG. 30 the relative moving distance in the Y-axis is the relative position of the front edge of the droplet, defining the final distance of one step of water movement as 1. The result demonstrates that the tested EWOD faces challenges when actuating body fluids, while the performance improvement brought by the increase of the operating voltage also vary significantly among different biofluids. Although some targeted improvements have been made to the EWOD platform to address system compatibility issues with respect to some specific sample types [37, 39, 67], the automated manipulation platform, in order to process a large number of samples in parallel, should still be adaptable across various samples and free from parameter adjustments as samples change. On the contrary, according to the characterization of the present invention (FIGS. 8 and 11), liquid conductivity and protein concentration will not have a significant effect on the EPD-based droplet actuation. When three biofluids (serum, saliva, urine) are tested on the proposed EPD-based droplet robotics system, all the tested samples can move smoothly with essentially no difference in actuation performance and without altering any parameter settings (FIG. 29B).

The superiority of EPD-based droplet robotics system of the present invention can be showcased in biochemical laboratory tasks by utilizing the system to conduct bioassays for lithium detection in various biofluids. Detection of lithium concentration in multiple body fluids can help to establish the metabolic relationship of the lithium drug in human body, thus contributing to non-invasive drug monitoring and precise medication for patients with bipolar disorder [68, 69]. To achieve the detection of lithium concentration in different biofluids, a microfluidic detection chip is designed and powered by the EPD-based droplet robotic system (FIG. 29C). The detection chip is designed to perform two calibrations and one sample detection in parallel for each test (FIG. 29D). On the detection chip, three reagent loading areas are divided to load masking, probe, and buffer solution, respectively, while three working regions are designated for merging, mixing, and reacting these reagents with calibration samples/testing sample, respectively. The overall operation flow of the system is demonstrated with two in-situ calibrations and one sample detection as a group.

In practical application, the test contents can be adjusted on demand, for example, if a standard calibration curve is known, three sample detections can be directly conducted as a group. As a demonstration, in the initial state (step 0), the two working areas for in-situ calibration are preloaded with two calibration samples of known lithium concentration, and the masking solution is also preloaded as shown in FIG. 29D. After loading the tested bio-sample three EPD grippers can be programmed to work collaboratively to implement the steps of the automated assay within the detection chip, including sample preparation, calibration 1, calibration 2, and sample detection. The tasks executed by each EPD gripper, and their trajectories are listed step-by-step along with representative screenshots, as shown in FIG. 29E.

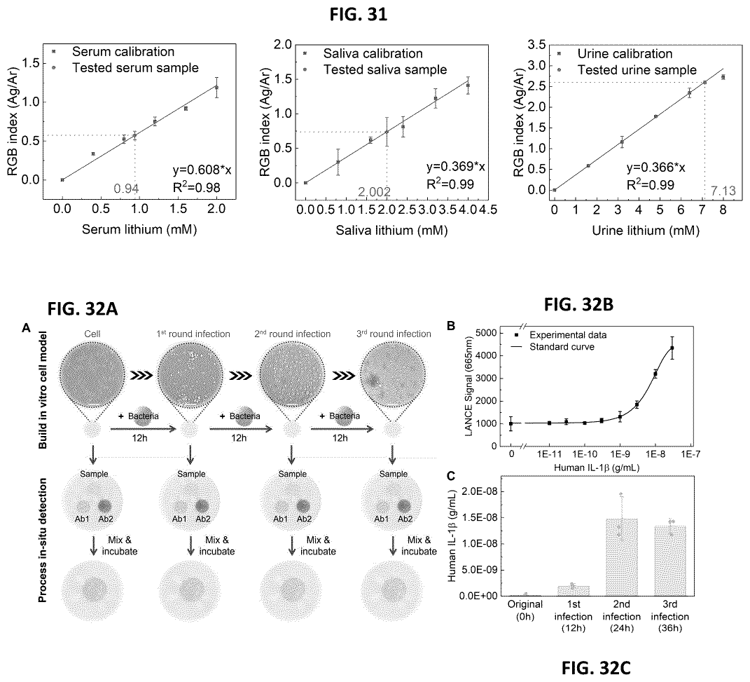

In the sample preparation stage (step 0-2), after loading the tested real bio-sample onto the chip, EPD gripper 1 and 2 will transport the sample and masking solution to sample region for mixing. This step is to keep other ions in the real bio-samples from influencing the test results. In the second stage of Calibration 1 (step 3-7), buffer and probe solutions are injected into the chip, respectively (step 3 and 5). Meanwhile, EPD gripper 2 and 3 will capture the generated sub-droplets and transport them to the calibration region (A) to mix with the prepared calibration sample (step 4 and 6). Lithium ions within the sample will bind to the probe after dilution, thereby shifting the absorbance profiles quantitatively (step 7). Similarly, the generation, transporting and mixing process of buffer and probe solutions are repeated for the third stage of Calibration 2 and fourth stage of Sample detection, respectively (step 8 and 9). Particularly, EPD grippers 1 and 2 are in charge of transporting and mixing the tested bio-sample with the masking solution, shielding other interfering ions in the bio-sample. EPD grippers 2 and 3 are responsible for capturing the injected sub-droplets of buffer and probe solutions and mixing them with the prepared calibration sample/tested bio-sample. Lithium ions within the sample will bind to the probe after dilution, thereby shifting the absorbance profiles quantitatively. In this way, two in-situ calibrations and one real bio-sample detection can be performed automatically, and the concentration of lithium in the tested bio-sample can be calculated based on the linear calibration curve. FIG. 31 The tested human serum, saliva, and urine lithium concentrations show no statistically significant difference from the reference values (P>0.05, FIG. 29F), demonstrating the reliability of the bioassay results accomplished by the EPD-based droplet robotic system. In addition to measuring the absorbance at specific wavelengths, similar standard curves and detected results can also be derived by simple in-situ photography and RGB analysis, offering the feasibility of further improving the integration of the system (FIG. 32).

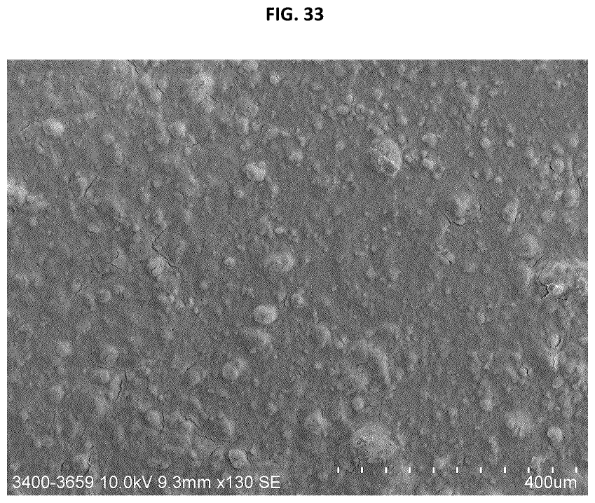

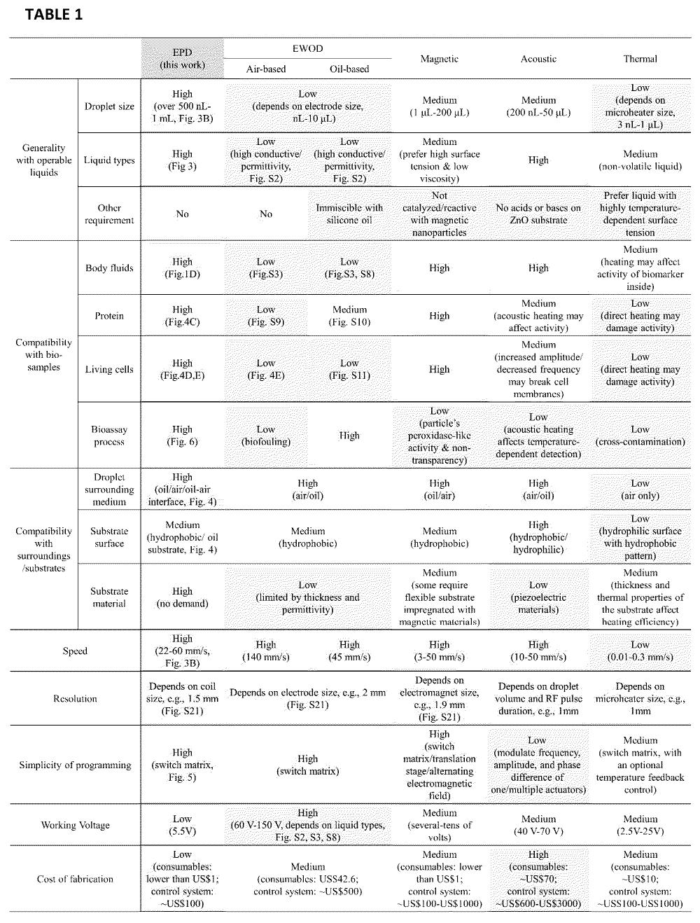

Besides the application example of automating a bioassay for diverse biofluids, EPD is also validated for establishing cell-bacteria models with dynamic monitoring. As a demonstration, an in vitro cell-bacteria model of inflammation is established and is used in-situ detection of a generated inflammatory mediator, IL-1B, on the EPD-based system (FIGS. 33A & 33B). By dynamically repeating bacterial infection of cells with the EPD-based droplet robotic system, the result validates the non-monotonic relationship between the concentration of inflammatory mediators and repeated bacterial infections, which can help to explore the generation of inflammatory mediators and the connection between diseases and inflammatory mediators [99-101].

The application of the EPD-based droplet robotic system for establishing in vitro cell-bacteria model of inflammation and in-situ detecting of the inflammatory mediator of human IL-1β is shown in FIG. 33A as a schematic diagram of the workflow for establishing a cell-bacteria model of inflammation and in-situ detecting of the concentration of inflammatory mediator on EPD-based system. Scale bar: 50 μm. FIG. 33B shows the standard curve of the concentration of human IL-1B. FIG. 33C is a bar graph of the detected concentration of human IL-1β after 1st, 2nd, and 3rd infection of bacteria. The result shows that the infection of 10% concentration of bacteria can increase the concentration of generated IL-1β by 11 times in 12 hours. The second infection with the same concentration of bacteria can further increase the IL-1β concentration by about 7 times in another 12 hours. At this point, the cell membrane begins to become transparent, but most cells remain intact. The subsequent third bacterial infection causes most of the cells to break up and die, while the concentration of inflammatory mediators basically remains the same as in the second infection. Error bars, SD (n=3).

In the two applications demonstrated above, droplets of volumes ranging from 5 μL to 1 mL are manipulated, while six different solutions, living cells, living bacteria, and three kinds of body fluids are also operated, taking full advantages of EPD's superior liquid operability and biocompatibility.

Throughout the process, droplets of volumes ranging from 5 μL to 250 μL are manipulated, while the operated liquid types involve 6 different solutions or biofluids, fully demonstrating the generality of the EPD-based Multiphysics droplet robotics systems. Furthermore, the proposed system also exhibits the ability to perform spatial crossover manipulation, thus creating the potential to work in parallel with multiple robots. Compared with other workstations that repeat the same experimental steps in a linear temporal manner, the EPD-based Multiphysics droplet robotics system of the present invention demonstrates a higher flexibility. Therefore, based on the demonstrated applications, the proposed EPD-based droplet robotic system shows wide applicability and impact on scientific research, with the potential for further applications in multiple fields that require precise liquid manipulations.

Using the proposed EPD-based droplet robotic system, the linear standard curve for serum lithium, saliva lithium, and urine lithium can be established (FIG. 31). The lithium concentration in the tested real serum/saliva/urine samples can also be quantitatively calculated from it (red points in FIG. 31 where the error bars, SD (n=3)). The tested human serum, saliva and urine lithium concentrations statistically show no significant difference from the reference values (P>0.05, FIG. 29F), demonstrating the reliability of the bioassay results accomplished by the EPD-based droplet robotic system. In addition to measuring the absorbance at specific wavelengths, similar standard curves and detected results can also be derived by simple in-situ photography and RGB analysis, offering the feasibility of further improving the integration of the system (FIG. 32). To establish a standard curve, the RGB index of the reagent blank (0 μM) was subtracted from the measured RGB index of other calibration samples. Then the background-subtracted RGB index of all calibration samples was plotted and the slope of the linear fitted standard curve was calculated. A white LED shadowless light acted as a background and a camera (PowerShot G7X Mark III, Canon) was used to take pictures of the mixed droplets. The photographs taken were processed in Adobe Photoshop to obtain the value of R and G though RGB analysis. RGB was defined as: index=Ag/Ar, where Ar=−log(R/255) and Ag=−log(G/255). As a result, the lithium concentration in the tested real sample can be calculated from it (red points). Error bars, SD (n=3).

By demonstrating automated detection of lithium concentration in different biofluids, the EPD-based droplet robotic system proved to be compatible with various liquid types and bio-samples, programmable, and highly integrated, offering the potential to automate the execution of highly quantitative biochemical tests.

A droplet robotic system based on the mechanism of EPD is disclosed, which addresses the compatibility issues of the existing droplet actuation platforms with respect to liquid types and biochemical samples. The EPD mechanism of the present invention utilizes electret material to generate a non-uniform electrostatic field, polarizing and attracting various liquid droplets. Compared with the traditional liquid polarization generated by AC/DC electric field, EPD employs the intrinsic electrostatic charges carried by the electret instead. Therefore, EPD does not generate conduction current and differs at the level of equivalent circuit models, leading to different variables and application scenarios. Thus, the EPD mechanism complements the existing principle of liquid polarization from an electrostatic perspective.

Benefiting from the novel EPD mechanism, we validate the EPD-based droplet actuation is validated. It has superior adaptability with liquid types and biochemical samples, while also achieving full automation based on a Multiphysics control system. Compared with the existing droplet actuation platform, the proposed EPD-based droplet robotic system exhibits a high generality of operable liquid types (various inorganic/organic liquids with relative permittivity ranging from 2.25-84.2 and volume ranging from 500 nL-1 mL), high compatibility with biochemical samples (multiple body fluids, proteins, and living cells), high compatibility with substrates and surroundings (air/oil/air-oil interface), high actuation speed (up to 60 mm/s), low working voltage (5.5 V), and low cost of fabrication (lower than US$1 for consumables and ˜US$100 for control system) (Table 1). Thus, it exhibits significant advantages in terms of operable liquid types and compatibility with bio-samples. EPD utilizes the polarization of dielectrics in a non-uniform electrostatic field, therefore demonstrating the potential for manipulating non-aqueous or non-conductive liquids. Based on both simulations and experimental results, EPD is proved to possess generality for various inorganic/organic liquids, while the variations in droplet volume (nL-mL), electrical conductivity, and relative permittivity (2.25-84.2) over common ranges do not prohibit the manipulation of liquids. Furthermore, the external stimulus required for EPD actuation is a non-uniform electrostatic field, which avoids the effect of Joule heating on biological samples and thus guarantees the compatibility of various bio-samples, such as body fluids, proteins and living cells. To provide automation, a Multiphysics system is designed to couple with EPD, consisting of a programmable control matrix that generates a regionalized electromagnetic field, EPD grippers which can be controlled by the programmable magnetic field and induce mobile non-uniform electrostatic field and a target droplet that can be polarized. Its advantages in generality of operable liquids, biocompatibility, and programmability endow it with the potential to assist basic scientific investigation as an automated experimental platform, which can be used in automated lithium monitoring of multiple biofluids.

To further enhance its adaptability in multidisciplinary applications in practice, the EPD-based droplet robotic system can be developed from both technical and application perspectives. From the technical perspective, the system can be miniaturized, modularized and integrated to achieve fluid manipulation at the nanoscale, which is consistent with the trend towards smaller and flexible systems in scientific research. The system is mainly designed to manipulate droplets on a μL scale (500 nL-1 mL). If it is downsized while maintaining the original design, the charge density of the electret needs to be increased to ensure functionality (FIG. 25). Besides, it can also be microfabricated into a 2D charge distribution-controllable electret material. This approach has the potential to actuate droplets by directly programming the local electric field distribution without physically moving the electret material, thus further reducing the size of the system.

Further, an in-situ image processing function could be integrated into the system to form a “result analyze module.” The temperature control function could also be integrated to form a “heating and cooling module.” By integrating other auxiliary functions into the system to form specific modules, steps for different experimental requirements can be completed in situ by simply activating and combining different modules in sequence. This modularization can also ensure the system's easy integration into other laboratory equipment and can enable the development of miniaturized and portable systems for field studies. Another promising area of technical development lies in the improvement of controllability and speed. At the actuation system level, the magnetic force generated by the programmable control matrix can be further enhanced by increasing the current (e.g. replacing switch ICs with higher current threshold chips) or modifying the coil design (e.g. more layers of coils), increasing system robustness and switching frequency. At the actuation material level, different electret materials can be utilized (e.g. CYTOP, which can provide a higher surface charge density up to 2 mC/m² for a 15-μm thick film [102]) or apply different charging methods (e.g. corona charging or electron-beam irradiation [103]) to further increase the surface charge density of the electret, providing a larger actuation force. In terms of application advancements, the proposed droplet robotic system provides new access to accomplish high-throughput and high-precision experiments, promoting experimental efficiency in the future, for example by the incorporation of machine learning and artificial intelligence (AI) into the system of the present invention. AI can be employed to help analyze massive amounts of data obtained from automated systems to unearth the buried correlations among various parameters and results. The learning capacity from past experiences will not only provide the potential to improve the design of the steps of various experiments, but will also break through bottlenecks in scientific development, such as finding unknown parameters that affect human diseases. In terms of the application advancements, the proposed droplet robotic system provides a new access to accomplish high-throughput and high-precision experiments, highly promoting the experiments efficiency in the future. Besides, the automated system also provides the possibility of remote experiments, especially for experiments involving hazardous operations and harmful chemicals. By remotely uploading commands to systems located in the lab, technicians can perform experiments and obtain experimental data in a secure manner. This approach of remote experimentation also lays the foundation for promoting communication and cooperation between laboratories, facilitating the real-time sharing of research results.

The EPD-based droplet robotic system exhibits a high generality of operable liquid types, compatibility with biochemical samples and substrates, and overwhelmingly collective performances in terms of programmability, cost of fabrication, and power consumption. It shows potential for applications in automated material synthesis, medical diagnostics, drug development, etc., and is expected to profoundly impact a myriad of scientific disciplines, propelling the application of robotic system for scientific research.

In carrying out the tests set forth herein the following materials were used. HFE-7500 (Novec Engineered Fluid, 3M) was used as the oil substrate for EPD-based droplet actuation. 0.05% surfactant (Pico-Surf, Sphere Fluidics) could also be added in HFE-7500 to adjust the shape and surface area of the droplet floating on HFE surface. As for the hydrophobic substrate, superhydrophobic coating (204A, Wateroff) was spin-coated onto the polyethylene terephthalate (PET) film sheets, resulting in a contact angle of 163° after drying for 24 hours (FIG. 17B). Oil substrate was used for most of the experiments unless otherwise specified. DI water, HCl (Aladdin), H₂O₂ (QuantaRed Stable Peroxide Solution, Thermofisher), Paraffin (Aladdin), Glycerol (Sigma-Aldrich), Triacetin (Aladdin), Hexadecane (Sigma-Aldrich) were actuated by EPD respectively. Methylene blue (TCI), oil red O (C.1.26125, Aladdin) and rhodamine B (Aladdin) were added to visualize the movement of transparent droplets in some optical image demonstrations.

The negatively charged electret sheet was made of PTFE and was charged by contact electrification with copper, while the positively charged electret sheet was made of glass and was charged by contact electrification with PTFE. By varying the amount of friction, the amount of charge obtained by the electret can be adjusted accordingly. To measure the charge amount possessed by the electret, the electret was placed within a Faraday cup connected with a programmable electrometer (6514, Keithley Instruments model) under the charge measurement model.

In the characterization experiments, one slice or sheet of electret (35×30×0.2 mm) was used to actuate a droplet of 20 μL floating on the oil surface, unless otherwise specified. To quantitatively characterize the process of EPD-based droplet actuation, the movement of the droplet was analyzed with a software tracker to calculate its location, velocity, and acceleration (FIG. 5F). Dyes were introduced to assist the tracking of the target droplet. Specifically, to measure the effective actuation distance, the charge amount possessed by the electret was measured at the beginning of each test, and then attached to the self-constructed slider to approach the droplet horizontally with a height of 10 mm above the droplet. When the droplet started to move after the electret moved to a certain distance, the horizontal distance between the two at this point was defined as the effective actuation distance (FIG. 5G). To measure the minimum and maximum height difference between the electret and droplet for the required effective actuation, the charge amount possessed by the electret was also measured first, and then attached to the self-constructed slider to approach the droplet vertically. The electret was repeatedly moved laterally within about 10 mm from the droplet as it approached the droplet vertically. When the droplet began to move with the electret at a certain height, this height was defined as the maximum height difference required for effective actuation (blue line in FIG. 5H). As the electret continued to descend to a certain height and the droplet was absorbed into the electret and contact occurred, this height was then defined as the minimum height difference required for effective actuation (yellow line in FIG. 5H). To measure the max velocity of droplet actuation, electret after charge measurement was attached to the self-constructed slider at 5, 8, 11 mm above the droplet. The electret accelerated laterally and actuated the droplet along with it. The maximum velocity of the droplet was analyzed by the Tracker (FIG. 5I).

Simulation of the EPD-based droplet actuation was conducted using finite element analysis tools (COMSOL Multiphysics 5.4). Several simplifications were made during modeling and the scenario was simplified to two dimensions (2D). The surrounding environment of air was modeled as a square shape with a dimension greatly larger than the electret and droplet, and all the surface boundaries were set grounded. The electrostatic interactions in the system were considered dominating, thus other physical phenomena were ignored in the simulation. According to the measured experiments parameters, the electret was set as a rectangular of 6×2 mm, with surface charge density of −1.74×10⁻⁵ C/m², while the droplet was set as a circle with radius of 3 mm in most cases, unless otherwise specified. To analyze the average Maxwell stress tensor applied to the droplet, line averages of the X component of the Maxwell stress tensor applied on the circular edge of the droplet were calculated. In FIG. 5C, to demonstrate how the net charge carried by the droplet would affect the attraction from both the positive electret and the negative electret, the droplet was additionally set to carry a spatial charge density of 2×10⁻⁴ C/m³ according to the measurement [47], and the electret was set to possess surface charge density of ±1.74×10⁻⁵ C/m², respectively. In FIG. 5E, to quantify the effect of droplet's charge density, the droplet was set to carry a spatial charge density of 0 and +2×10⁻⁴ C/m³ according to the measurement [59], respectively, and the average Maxwell stress tensor applied to the droplet was calculated with various droplet locations. The electret was set to locate at 0 mm. In FIG. 5E, the simulation setup was adjusted according to the experimental situation shown in FIG. 5F. The electret was set as a rectangular of 0.2×35 mm, with a surface charge density of −2×10⁻⁵ C/m², while the droplet was set as a circle with a radius of 2.7 mm. In FIGS. 8C and 8D, the conductivity and relative permittivity of the droplet was adjusted on demand in simulation to demonstrate EPD's generality of operable liquid types.

All human urine and saliva samples were obtained following The University of Hong Kong, Human Research Ethics Committee approved research project, HREC No. EA230092. Upon collection, urine and saliva was centrifuged at 6000 rpm for 20 min and the supernatant was frozen at −20° C. The human serum (H3667) was purchased from Sigma-Aldrich, which is heat inactivated, from human male AB plasma, USA origin, sterile-filtered. The human serum was frozen at −20° C. in small aliquots until used.

Droplets of fluorescent protein (FITC-labeled goat anti-rabbit IgG (H+L), Beyotime) floating on oil surface were actuated by EPD, while the whole process was observed and recorded by fluorescence microscopy. To analyze the fluorescence intensity of the droplet and its moving path, mean grey value of four different points were calculated via ImageJ software in droplet, moving path, and background, respectively. The average value in background was then subtracted from the value of droplet and moving path.

A549 cells, obtained from the American Type Culture Collection (CCL-185), were utilized in living cell actuation experiments. First, A549 cells were maintained in DMEM supplemented (10569010, Gibco) with 10% fetal bovine serum (10099141, Gibco) and 1% penicillin-streptomycin (15070063, Gibco). Cells were then incubated at 37° C., 5% CO2 for 48 h and harvested for actuation experiments. To demonstrate the cell viability during the actuation process, three droplets containing A549 cells, and the culture medium were actuated by EPD. A 10 μL sample from each cell suspension droplet was extracted and homogeneously mixed with 10 μL of 0.4% Trypan blue stain (15250061, Gibco) after being actuated for 1, 3, 5, 7 and 9 minutes and counted by Countess II FL Automated Cell Counters (Invitrogen, Thermo Fisher Scientific corporation), respectively. Meanwhile, three control droplets were also dropped on the petri dish and exposed to air together with the experimental group. A 10 μL sample from each droplet was also extracted and homogeneously mixed with 10 μL of Trypan blue stain at 1, 3, 5, 7 and 9 minutes and counted accordingly. The effect of EPD on cell proliferation was also tested. After treating the droplet containing the A549 cells with EPD for 30 minutes, the cells were then incubated for another 12 hours. A 10 μL sample from each droplet was extracted and homogeneously mixed with 10 μL of Trypan blue stain before and after each entire experiment, repeated for three times. Viable and nonviable cells concentrations for each test were then calculated by Countess II FL Automated Cell Counters.

THP-1 cells, obtained from the American Type Culture Collection (TIB-202), were utilized in experiments analyzing the impact of the EPD system setup on cell culture. First, THP-1 cells were maintained in RPMI 1640 Medium (11875093, Gibco) with 10% fetal bovine serum (10099141, Gibco) and 1% penicillin-streptomycin (15070063, Gibco). Cells were then incubated at 37° C., 5% CO2 for 48 h and harvested for experiments. Then, three 300 μL droplets containing THP-1 cells and the culture medium were placed on EPD system and cultured for 24 hours without power supply. After 24 hours, 10 μL from each cell suspension droplet was extracted and mixed with 10 μL of 0.4% Trypan blue stain homogeneously, repeated for three times. Viable and nonviable cells concentration for each test were then calculated by Countess II FL Automated Cell Counters.

In carrying out EWOD experiments, two pieces of ITO glass were used to form the upper and lower plates. The ITO electrode pattern on both the upper and lower plates was fabricated by photolithography using negative photoresist (SU-8 2025, MicroChemicals) on mask aligner (MA/BA6, SUSS) (58). The upper plate was then coated with a 50 nm Teflon-AF layer by spin-coating the solution (1 wt % in FC-40, 3M, USA) at 1500 rpm for 60 s. The lower plate was deposited with a 3.5 μm thick parylene-C film using low-pressure chemical vapor deposition (CVD) equipment (LH300, LaChi Enterprise), then a Teflon-AF solution (1 wt % in FC-40, 3M, USA) was spin-coated on the parylene-C film at 1500 rpm for 60 s. The assembled plate was baked at 165° C. on a hotplate for 15 min. The amplitude of the voltage used when applying the ITO glass on the digital microfluidic platform is from 60V to 150V, with the frequency of 1000 Hz . . .

Water, glycerol, triacetin, human serum, human saliva and human urine were tested on the fabricated EWOD, respectively. Specifically, 1.8 μL droplet was used in the air-based EWOD, while 1 μL droplet with 0.5 μL Decamethyltetrasiloxane (Aladdin) was used in the oil-based EWOD. To quantitatively analyze the actuation of these liquids, the software Tracker was used to track the front edge of the droplet and calculate its real-time position based on video recordings (FIGS. 5A-5G). The average position of the front edge of the droplet at the 5th-5.5th second after activating the neighbor coil/electrode is defined as the relative moving distance in FIG. 2D, while the distance between two neighboring coil/electrode was normalized as one. 0.05% BSA solution was tested on EWOD, where the protein adsorption on EWOD is observed from fluorescence microscopy.

Living A549 cells in culture medium were also tested on EWOD. Due to protein adsorption, the droplet cannot be actuated directly on the double-plate EWOD. Therefore, the previously described EWOD device was simplified to a pair of ITO glass plate electrodes (50×50× 1.0 mm) to investigate how the electric field applied between EWOD's upper and lower plate would affect living cells. Two ITO glass plate electrodes sandwiched an insulated rubber tape with a thickness of 1 mm as a spacer. The coating process for the ITO glass was the same as that mentioned above. To analyze the impact of electrowetting effect on cell proliferation, 300 μL droplets contained living A549 cells were added between the electrodes for air-based EWOD, while 50 μL Decamethyltetrasiloxane was additionally introduced for each droplet on oil-based EWOD. The 300 μL droplet containing the living A549 cells was added between the electrodes, and a DC voltage of 150 V was applied between the two electrodes for 30 minutes. After that, a pipette was used to flush the droplet repeatedly to wash down the cells attached to the substrate and to distribute the cells evenly within the droplet. The droplet was then extracted and incubated in an adherent wall culture for another 12 hours. A 10 μL sample from the cultured cells was extracted and mixed with 10 μL of Trypan blue before and after. The whole experiment was repeated three times. Viable and nonviable cell concentrations for each test were then calculated by Countess II FL Automated Cell Counters. To analyze the impact of oil-based EWOD system setup with cell culture, 300 μL droplets contained living THP-1 cells and 100 μL Decamethyltetrasiloxane were added between the electrodes for oil-based EWOD and cultured for 24 hours without power supply. A 10 μL sample from each droplet was extracted and mixed with 10 μL of Trypan blue stain homogeneously before and after the whole experiments, repeated for three times. Viable and nonviable cells concentration for each test were then calculated by Countess II FL Automated Cell Counters.

The programmable control matrix (FIGS. 21A-21C) was established on a multi-layer PCB, which contained 32×32 coils matrix, four row switches MAX14662 (Maxim Integrated), two column switches MC33996 (NXP Semiconductors), and a 1×10 pin header for power supply and communications with an Arduino Uno. The coils consisted of three turns of 1 mm wide wire and stacked three layers on the PCB, powered by a 0.2 A current. By uploading codes through a computer to the Arduino Uno, it could selectively turn on the specific row switch and column switch, powering the coil at the designated coordinates and generating a local electromagnetic field.

The EPD gripper was made of a hybrid of electret (PTFE) and magnetically responsive material (Neodymium-Iron-Boron magnet, DH101, 1/32 inch in thickness and 1/10 inch in diameter, K&J Magnetics). The electret material formed the shape of the gripper through origami, while the magnetically responsive material was adhered to the bottom of the gripper, providing the ability to be driven by the magnetic field. In the EPD-based droplet robotic system, the EPD grippers were suspended beneath the control matrix by magnetic force. To balance the self-weight of the gripper, an actuation magnet is also utilized and placed above the control matrix. It could enhance the localized magnetic field generated by the coils and provide extra attractive force to the EPD gripper. When switching on coils at different coordinates, the actuation magnet and the suspended EPD gripper could be actuated simultaneously through magnetic force. To minimize friction as the EPD gripper moves, a smooth pad (PET and glass sheet) was placed between the gripper and the control matrix.

Simulation of the Multiphysics droplet robotic system was conducted using finite element analysis tools (COMSOL Multiphysics 5.4). Several simplifications were made during modeling. The surrounding environment of air was modeled as a cube shape with a dimension greatly larger than the coils and grippers, and all the surface boundaries were set grounded. To simulate the magnetic field generated by the control matrix, the electromagnetic interactions in the system were considered dominating, thus other physical phenomena were ignored in the simulation. The three-layer coils were also simplified as a one-layer coil, and the inlets of the coils in each row are connected, while the outlets of the coils in each column are also connected (FIG. 8C). The results of the simulation were used to qualitatively characterize the distribution of the magnetic field. To simulate the electrostatic interaction between the EPD gripper and the droplet, electrostatic field physics was used. The simulation used the same EPD gripper dimensions as the experimental setup, and the surface charge density of the electret material was set to be −1.6×10⁻⁵ C/m². To calculate the force applied on the droplet, the X and Y components of the Maxwell stress tensor were integrated on the surface of the droplet (FIG. 8G). In the simulation of the whole system, magnetic and electrostatic field physics were utilized simultaneously. The actuation magnet was ignored during simulation, and the magnetic Maxwell stress tensor applied to the EPD gripper through the activated coil as well as the electric Maxwell stress tensor applied on the droplet through EPD gripper is demonstrated, qualitatively profiling the overall Multiphysics coupling in the whole system.

The microfluidic detection chip was 3D printed from photosensitive resin and having 7 mm in height and 50 mm in length and width. A superhydrophobic layer (NeverWet) was coated on the wall of the chip (FIG. 34). In use, the chip was glued to the petri dish with Epoxy (Devcon) and filled with HFE to provide the oil substrate. The demonstrated chip was designed to perform three tests in parallel, including three working regions and three reagent loading areas (FIG. 29D). For the probe and buffer loading area, considering these reagents need to be loaded repeatedly, two microtubes with a diameter of 0.034″ I.D.×0.052″ O.D. (LDPE, Scientific Commodities) were inserted at the bottom of the chip, and the inlet of the microtube located beneath the HFE-air interface. The microtubes were connected to two syringes installed on pumps (SPLab01, DK Infusetek). The preloaded probe solution and buffer solution were infused to the chip, and the generated sub droplets of buffer/probe would rise to the surface of the HFE due to buoyancy and were collected by the EPD grippers above.

To conduct calibration tests, 5 μL of the prepared bio-sample with known lithium concentration (LiCl solution spiked human serum with concentrations of 0 μM, 400 μM, 800 μM, 1200 μM, 1600 μM, 2000 μM; LiCl solution spiked human saliva with concentrations of 0 μM, 800 μM, 1600 μM, 2400 μM, 3200 μM, 4000 μM; LiCl solution spiked human urine with concentrations of 0 μM, 1600 μM, 3200 μM, 4800 μM, 6400 μM, 8000 μM) were mixed with 15 μL of masking solution (ab235613 lithium assay kit, Abcam) to form the calibration sample. These concentrations were selected based on the clinically empirical range of lithium in various human body fluids [71]. Due to the higher lithium concentration in human saliva and urine, the prepared saliva and urine lithium samples were diluted two-fold and four-fold, respectively, before mixing with masking solutions. In each calibration process, the prepared calibration sample needed to be mixed with 130 μL buffer and 100 μL probe solution (ab235613 lithium assay kit, Abcam). As for each real bio-sample detection process, the real sample of human serum/saliva/urine was spiked with LiCl solution (ab235613 lithium assay kit, Abcam) with the concentration serving as a reference value. The prepared bio-sample needed to be mixed with 15 μL of masking solution (ab235613 lithium assay kit, Abcam) first, and then mixed with 130 μL Buffer and 100 μL probe solution during sample detection process. Among them, buffer and probe solution were loaded by pump and microtubes connected to the buffer and probe loading area each time, while the masking, calibration samples, and tested bio-sample were directly preloaded inside of the chip before test.

The capture of the generated sub-droplet, transportation of reagents to the designated working area, merging and mixing of the reagents with samples were conducted by the EPD-based droplet robotic system. Each detection was repeated at least three times, and the practical process was not necessarily performed according to the combination of two calibration and one test sample. To obtain the tested result, the mixed droplet can be either extracted and transferred to a 96-well plate to measure absorbance at 540 nm and 630 nm by microplate reader (Spectramax iD5, Molecular Devices) or simply analyzed through in-situ photography and RGB analysis (as shown in FIG. 32). To obtain the lithium standard curve in FIG. 31, the absorbance ratio (OD₅₄₀/OD₆₃₀) of the reagent blank (0 μM) was subtracted from the measured absorbance ratios of other calibration samples. Then the background-subtracted absorbance ratio values of all calibration samples were plotted, and the slope of the standard curve was calculated. This standard curve could be used to calculate the measured value of lithium concentration for the tested bio-sample.

To demonstrate the step-by-step workflow, a group of tests consisted of two calibrations and one real bio-sample detection performed as an example. Dyed droplets were used instead of transparent real samples/reagents for clear demonstration. The operation process of the system was filmed with a camera (PowerShot G7X Mark III, Canon) from bottom up with an upward view (FIG. 29E). The video was filmed and edited in segmental settings to demonstrate the detailed step-by-step workflow and offer clear operation details. In the demonstration, droplets representing masking, calibration samples, and tested bio-sample were directly preloaded inside of the chip, while the solution representing buffer and probe were loaded by pump and microtubes. Three EPD grippers were programmed to work collaboratively to capture the generated sub-droplet, transport reagents to the designated working area, merge and mix of the reagents with samples automatedly. Specifically, according to FIG. 8E, in the sample preparation stage (step 0-2), after loading the tested bio-sample to the chip, EPD gripper 1 and 2 would transport the sample and masking solution to sample region for mixing. This step was to shield other ions in the bio-samples from influencing the test results. In the second stage of Calibration 1 (step 3-7), buffer and probe solutions were injected into the chip by pump, respectively (step 3 and 5). Meanwhile, EPD gripper 2 and 3 would capture the generated sub-droplets and transport them to the calibration region (A) to mix with the prepared calibration sample (step 4 and 6). Lithium ions within the sample would bind to the probe after dilution, thereby quantitatively shifting the absorbance profiles (step 7). Similarly, the generation, transporting and mixing process of buffer and probe solutions were repeated for the third stage of Calibration 2 and forth stage of Sample Detection, respectively (step 8 and 9).

To prepare the original bacteria and cells for experiments, Escherichia coli (E. coli; ATCC 25922) were cultured with Luria-Bertani (LB) medium at 37° C. overnight. Then, E. coli was harvested and washed three times with PBS using centrifugation (3000 rpm, 5 minutes). The obtained bacterial cells were resuspended and diluted to about 6×10⁷ CFU/mL in PBS for experiment. THP-1 cells were maintained in RPMI 1640 Medium (11875093, Gibco) with 10% fetal bovine serum (10099141, Gibco) and 1% penicillin-streptomycin (15070063, Gibco). Cells were then incubated at 37° C., 5% CO2 for 48 h. After that, the contents were transferred to a centrifuge tube and spun at 300 g for 4 mins. The cell pellet was resuspended in fresh RPMI 1640 Medium for experiment.

To establish the in vitro cell-bacteria model of inflammation with dynamic monitoring on the EPD system, 995 μl droplets containing 3×10⁶/mL THP-1 cells and 5 μL droplets containing 6×10⁷ CFU/mL E. coli were added. Three groups of cell droplets and bacteria droplets were merged and mixed by the EPD system individually, and subsequently incubated for 12 hours. Then, one of the mixed cell-bacteria droplets was observed under a microscope, labeled as “1st round infection sample”. The other two mixed cell-bacteria droplet were introduced with a new bacteria droplet, respectively, and then incubated for another 12 hours. After repeating same processes for the second and third droplet, “2^{nd} round infection sample” and “3rd round infection sample” were acquired, respectively. The concentration of generated human IL-1β in each sample could be detected by introducing 333 μl of the mixed antibody solution (containing 1.2 nM Eu-labeled anti-hIL1β Antibody and 12 nM ULight labeled anti-hIL1β Antibody, TRF1220C, LANCE Ultra IL1β (Human) Detection Kit, Revvity) to each sample immediately after sample acquisition. The mixed droplets were then incubated for 60 minutes on the EPD system.

After processing the samples and bioassay steps on the EPD system, the final droplets were extracted and centrifuged under 3000 rpm for 5 minutes to read the measurement value. The obtained supernatants were then transferred to a 96-well plate (60 μL per well) to conduct TR-FRET measurement with an excitation wavelength of 350 nm and an emission wavelength of 665 nm (Spectramax iD5, Molecular Devices). To obtain the human IL-1β standard curve, standard dilutions were prepared with fresh RPMI 1640 Medium and reconstituted hIL1β (TRF1220C, LANCE Ultra IL1β (Human) Detection Kit, Revvity). After mixing 45 μL of the standard dilution with 15 μl of the prepared antibody solution and incubating them for 60 minutes, same TR-FRET measurements were conducted, and the results were fitted by a sigmoidal dose-response curve.

The comparison in FIG. 5D was conducted based on the detail information in the TABLE, which was either based on the results of experiments (labeled with the number of the figure in which relative data are presented) or based on the references. For the perspectives of “1/working voltage” and “1/cost of fabrication”, the lower working voltage and cost of fabrication in the TABLE, the higher the evaluation result in FIG. 5D. For the perspectives of “generality with operable liquids”, “compatibility with biosamples”, and “compatibility with substrates & surroundings” which included multiple sub-indexes in the TABLE, their evaluation results were calculated by averaging the evaluations of corresponding sub-indexes.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

### REFERENCES

The cited references in this application are incorporated herein by reference in their entirety and are as follows:
[1] G.-Z. Yang et al., The grand challenges of <i>Science Robotics</i>. Science Robotics 3, eaar7650 (2018).
[2] P. E. Dupont et al., A decade retrospective of medical robotics research from 2010 to 2020. Science Robotics 6, eabi8017 (2021).
[3] A. Billard, D. Kragic, Trends and challenges in robot manipulation. Science 364, eaat8414 (2019).
[4] J.-L. Ferrer, N. A. Larive, M. W. Bowler, D. Nurizzo, Recent progress in robot-based systems for crystallography and their contribution to drug discovery. Expert Opinion on Drug Discovery 8, 835-847 (2013).
[5] A. G. Godfrey, T. Masquelin, H. Hemmerle, A remote-controlled adaptive medchem lab: an innovative approach to enable drug discovery in the 21st Century. Drug Discovery Today 18, 795-802 (2013).
[6] G. Schneider, Automating drug discovery. Nature Reviews Drug Discovery 17, 97-113 (2018).
[7] B. Burger et al., A mobile robotic chemist. Nature 583, 237-241 (2020).
[8] H. Zhao et al., A robotic platform for the synthesis of colloidal nanocrystals. Nature Synthesis 2, 505-514 (2023).
[9] H. Tao et al., Nanoparticle synthesis assisted by machine learning. Nature Reviews Materials 6, 701-716 (2021).
[10] M. Yip et al., Artificial intelligence meets medical robotics. Science 381, 141-146 (2023).
[11] H. Lin et al., Ferrobotic swarms enable accessible and adaptable automated viral testing. Nature 611, 570-577 (2022).
[12] W. Yu et al., A ferrobotic system for automated microfluidic logistics. Science Robotics 5, eaba4411 (2020).
[13] F. Kong, L. Yuan, Y. F. Zheng, W. Chen, Automatic Liquid Handling for Life Science: A Critical Review of the Current State of the Art. Journal of Laboratory Automation 17, 169-185 (2012).
[14] T. Chapman, Lab automation and robotics: Automation on the move. Nature 421, 661-663 (2003).
[15] F. Barthels, U. Barthels, M. Schwickert, T. Schirmeister, FINDUS: An Open-Source 3D Printable Liquid-Handling Workstation for Laboratory Automation in Life Sciences. SLAS TECHNOLOGY: Translating Life Sciences Innovation 25, 190-199 (2020).
[16] C. E. Reed, J. Fournier, N. Vamvoukas, S. M. Koza, Automated Preparation of MS-Sensitive Fluorescently Labeled N-Glycans with a Commercial Pipetting Robot. SLAS TECHNOLOGY: Translating Life Sciences Innovation 23, 550-559 (2018).
[17] H. Fleischer et al., Analytical Measurements and Efficient Process Generation Using a Dual-Arm Robot Equipped with Electronic Pipettes. Energies 11, 2567 (2018).
[18] A. Faiña, B. Nejati, K. Stoy, EvoBot: An Open-Source, Modular, Liquid Handling Robot for Scientific Experiments. Applied Sciences 10, 814 (2020).
[19] C. Cain-Hom et al., Mammalian Genotyping Using Acoustic Droplet Ejection for Enhanced Data Reproducibility, Superior Throughput, and Minimized Cross-Contamination. Journal of Laboratory Automation 21, 37-48 (2016).
[20] H. Tegally, J. E. San, J. Giandhari, T. de Oliveira, Unlocking the efficiency of genomics laboratories with robotic liquid-handling. BMC Genomics 21, 729 (2020).
[21] J. Čejková, T. Banno, M. M. Hanczyc, F. Štěpánek, Droplets As Liquid Robots. Artificial Life 23, 528-549 (2017).
[22] M. J. Kiani et al., Robotic digital microfluidics: a droplet-based total analysis system. Lab on a Chip 23, 748-760 (2023).
[23] Y. Zeng et al., Miniaturizing chemistry and biology using droplets in open systems. Nature Reviews Chemistry 7, 439-455 (2023).
[24] T. Henkel et al., From Microtiter Plates to Droplets—There and Back Again.

### Micromachines 13, 1022 (2022).

[25] W. Feng, E. Ueda, P. A. Levkin, Droplet Microarrays: From Surface Patterning to High-Throughput Applications. Advanced Materials 30, 1706111 (2018).
[26] Y. Zhu et al., Nanoliter-Scale Protein Crystallization and Screening with a Microfluidic Droplet Robot. Sci Rep 4, 5046 (2014).
[27] V. Jain, R. K. Dwivedi, K. Muralidhar, Closed EWOD-based low-cost portable thermal detection system for point-of-care applications. Sensors and Actuators A: Physical 346, 113831 (2022).
[28] K. Choi et al., Automated Digital Microfluidic Platform for Magnetic-Particle-Based Immunoassays with Optimization by Design of Experiments. Analytical Chemistry 85, 9638-9646 (2013).
[29] D. Albin et al., PhageBox: An Open Source Digital Microfluidic Extension With Applications for Phage Discovery. IEEE Transactions on Biomedical Engineering, 1-10 (2023).
[30] C. Yang, Q. Zeng, J. Huang, Z. Guo, Droplet manipulation on superhydrophobic surfaces based on external stimulation: A review. Advances in Colloid and Interface Science 306, 102724 (2022).
[31] Y. Zhang, N.-T. Nguyen, Magnetic digital microfluidics—a review. Lab on a Chip 17, 994-1008 (2017).
[32] H.-H. Shen, S.-K. Fan, C.-J. Kim, D.-J. Yao, EWOD microfluidic systems for biomedical applications. Microfluidics and Nanofluidics 16, 965-987 (2014).
[33] X. Ding et al., Surface acoustic wave microfluidics. Lab on a Chip 13, 3626-3649 (2013).
[34] A. A. Darhuber, J. P. Valentino, S. M. Troian, S. Wagner, Thermocapillary actuation of droplets on chemically patterned surfaces by programmable microheater arrays. Journal of Microelectromechanical Systems 12, 873-879 (2003).
[35] S.-K. Fan, T.-H. Hsieh, D.-Y. Lin, General digital microfluidic platform manipulating dielectric and conductive droplets by dielectrophoresis and electrowetting. Lab on a Chip 9, 1236-1242 (2009).
[36] H. Geng, J. Feng, L. M. Stabryla, S. K. Cho, Dielectrowetting manipulation for digital microfluidics: creating, transporting, splitting, and merging of droplets. Lab on a Chip 17, 1060-1068 (2017).
[37] J. Li, N. S. Ha, T. L. Liu, R. M. van Dam, C.-J. ‘Cj’ Kim, Ionic-surfactant-mediated electro-dewetting for digital microfluidics. Nature 572, 507-510 (2019).
[38] L. Malic, D. Brassard, T. Veres, M. Tabrizian, Integration and detection of biochemical assays in digital microfluidic LOC devices. Lab on a Chip 10, 418-431 (2010).
[39] E. N. A. Latip et al., Protein droplet actuation on superhydrophobic surfaces: a new approach toward anti-biofouling electrowetting systems. RSC Advances 7, 49633-49648 (2017).
[40] L. Gao et al., Intrinsic peroxidase-like activity of ferromagnetic nanoparticles. Nature Nanotechnology 2, 577-583 (2007).
[41] H. Wei, E. Wang, Fe3O4 Magnetic Nanoparticles as Peroxidase Mimetics and Their Applications in H₂O₂ and Glucose Detection. Analytical Chemistry 80, 2250-2254 (2008).
[42] A. Salehi-Reyhani et al., Chemical-Free Lysis and Fractionation of Cells by Use of Surface Acoustic Waves for Sensitive Protein Assays. Analytical Chemistry 87, 2161-2169 (2015).
[43] H. Geng, S. K. Cho, Dielectrowetting for digital microfluidics: principle and application. A critical review. Reviews of Adhesion and Adhesives 5, 268-302 (2017).
[44] J. Voldman, ELECTRICAL FORCES FOR MICROSCALE CELL MANIPULATION. Annual Review of Biomedical Engineering 8, 425-454 (2006).
[45] M. Hakoda, Y. Hirota, Correlation between dielectric property by dielectrophoretic levitation and growth activity of cells exposed to electric field. Bioprocess and Biosystems Engineering 36, 1219-1227 (2013).
[46] O. D. Velev, B. G. Prevo, K. H. Bhatt, On-chip manipulation of free droplets.

### Nature 426, 515-516 (2003).

[47] R. Zhang et al., Liquid-Liquid Triboelectric Nanogenerator for Harvesting Distributed Energy. Advanced Functional Materials 32, 2208393 (2022).
[48] S. Lin, L. Xu, A. Chi Wang, Z. L. Wang, Quantifying electron-transfer in liquid-solid contact electrification and the formation of electric double-layer. Nature Communications 11, 399 (2020).
[49] H. Dai et al., Controllable High-Speed Electrostatic Manipulation of Water Droplets on a Superhydrophobic Surface. Advanced Materials 31, 1905449 (2019).
[50] L. Zheng et al., Self-Powered Electrostatic Actuation Systems for Manipulating the Movement of both Microfluid and Solid Objects by Using Triboelectric Nanogenerator. Advanced Functional Materials 27, 1606408 (2017).
[51] J. R. Millman, K. H. Bhatt, B. G. Prevo, O. D. Velev, Anisotropic particle synthesis in dielectrophoretically controlled microdroplet reactors. Nature Materials 4, 98-102 (2005).
[52] N. Abd Rahman, F. Ibrahim, B. Yafouz, Dielectrophoresis for Biomedical Sciences Applications: A Review. Sensors (Basel) 17, (2017).
[53] M. Abraham, The classical theory of electricity and magnetism. (Blackie & Son Limited, 1932), vol. 5.
[54] R. Pethig, Review Article—Dielectrophoresis: Status of the theory, technology, and applications. Biomicrofluidics 4, (2010).
[55] [55]. B. Hadwen et al., Programmable large area digital microfluidic array with integrated droplet sensing for bioassays. Lab on a Chip 12, 3305-3313 (2012).
[56] A. A. Maryott, E. R. Smith, Table of dielectric constants of pure liquids. (US Government Printing Office, 1951), vol. 514.
[57] C.-H. Chen, S.-L. Tsai, M.-K. Chen, L.-S. Jang, Effects of gap height, applied frequency, and fluid conductivity on minimum actuation voltage of electrowetting-on-dielectric and liquid dielectrophoresis. Sensors and Actuators B: Chemical 159, 321-327 (2011).
[58] Y. Xing et al., A robust and scalable active-matrix driven digital microfluidic platform based on printed-circuit board technology. Lab on a Chip 21, 1886-1896 (2021).
[59] S. Zhu, H. Yi, Z. Ni, C. Song, in 2007 IEEE/ICME International Conference on Complex Medical Engineering. (2007), pp. 1720-1725.
[60] M. Praeger, Z. Li, J. M. Smallwood, P. L. Lewin, Numerical calculation of dielectrophoretic and electrostatic forces acting on micro-scale particles. Journal of Physics: Conference Series 646, 012047 (2015).
[61] B. Senf, W.-H. Yeo, J.-H. Kim, Recent Advances in Portable Biosensors for Biomarker Detection in Body Fluids. Biosensors 10, 127 (2020).
[62] C. Gabriel, S. Gabriel. (King's College, London, Department of Physics, 1996).
[63] S. Kavukcu, M. Turkmen, A. Soylu, F. Kuralay, Could conductivity be used as a parameter in urinalysis? J Pak Med Assoc 48, 238-240 (1998).
[64] A. Ranade, P. Undre, S. Barpande, J. Tupkari, S. Mehrotra, Salivary dielectric properties in oral cancer (OSCC) through time domain reflectometry at microwave region: the future alternative for diagnosis and treatment. Global Journal of Medical Research: F Diseases 16, 13 (2016).
[65] J. T. Busher, Serum albumin and globulin. Clinical methods: The history, physical, and laboratory examinations 3, 497-499 (1990).
[66] Y.-P. Lu et al., A Portable System to Monitor Saliva Conductivity for Dehydration Diagnosis and Kidney Healthcare. Sci Rep 9, 14771 (2019).
[67] V. N. Luk, G. C. H. Mo, A. R. Wheeler, Pluronic Additives: A Solution to Sticky Problems in Digital Microfluidics. Langmuir 24, 6382-6389 (2008).
[68] I. Lewińska, L. F. Capitán-Vallvey, M. M. Erenas, Thread-based microfluidic sensor for lithium monitoring in saliva. Talanta 253, 124094 (2023).
[69] S. Lin et al., Non-Invasive Touch-Based Lithium Monitoring Using an Organohydrogel-Based Sensing Interface. Advanced Materials Technologies 8, 2202141 (2023).
[70] Y. Jin et al., Electrostatic tweezer for droplet manipulation. Proceedings of the National Academy of Sciences 119, e2105459119 (2022).
[71] S. J. Shetty, P. B. Desai, N. M. Patil, R. B. Nayak, Relationship Between Serum Lithium, Salivary Lithium, and Urinary Lithium in Patients on Lithium Therapy. Biological Trace Element Research 147, 59-62 (2012).
[72] çetin, B. & Li, D. Dielectrophoresis in microfluidics technology. Electrophoresis 32, 2410-2427, doi: https://doi.org/10.1002/elps.201100167 (2011).
[73] Renaudot, R. et al. Optimization of Liquid DiElectroPhoresis (LDEP) Digital Microfluidic Transduction for Biomedical Applications. Micromachines 2, 258-273 (2011).
[74] Fan, S.-K., Hsieh, T.-H. & Lin, D.-Y. General digital microfluidic platform manipulating dielectric and conductive droplets by dielectrophoresis and electrowetting. Lab on a Chip 9, 1236-1242, doi: 10.1039/B816535A (2009).
[75] Velev, O. D., Prevo, B. G. & Bhatt, K. H. On-chip manipulation of free droplets. Nature 426, 515-516, doi: 10.1038/426515a (2003).
[76] Zhao, K. & Li, D. Direct current dielectrophoretic manipulation of the ionic liquid droplets in water. Journal of Chromatography A 1558, 96-106, doi: https://doi.org/10.1016/j.chroma.2018.05.020 (2018).
[77] Jones, T. B., Fowler, J. D., Chang, Y. S. & Kim, C.-J. Frequency-Based Relationship of Electrowetting and Dielectrophoretic Liquid Microactuation. Langmuir 19, 7646-7651, doi: 10.1021/la0347511 (2003).
[78] Wu, J. et al. Electric-Field-Induced Selective Directed Transport of Diverse Droplets. ACS Applied Materials & Interfaces 16, 4126-4137, doi: 10.1021/acsami.3c13792 (2024).
[79] Chen, K. et al. Accurate control of individual metallic nanowires by light-induced dielectrophoresis: Size-based separation and array-spacing regulation. Sensors and Actuators A: Physical 225, 139-147, doi: https://doi.org/10.1016/j.sna.2014.07.025 (2015).
[80] Gascoyne, P. R. & Vykoukal, J. Particle separation by dielectrophoresis. Electrophoresis 23, 1973-1983, doi: 10.1002/1522-2683 (200207) 23: 13<1973: Aid-elps1973>3.0.Co;2-1 (2002).
[81] Ahn, K. et al. Dielectrophoretic manipulation of drops for high-speed microfluidic sorting devices. Applied Physics Letters 88, doi: 10.1063/1.2164911 (2006).
[82] Brassard, D., Malic, L., Normandin, F., Tabrizian, M. & Veres, T. Water-oil core-shell droplets for electrowetting-based digital microfluidic devices. Lab on a Chip 8, 1342-1349, doi: 10.1039/B803827A (2008).
[83] Ng, A. H. C., Li, B. B., Chamberlain, M. D. & Wheeler, A. R. Digital Microfluidic Cell Culture. Annual Review of Biomedical Engineering 17, 91-112, doi: 10.1146/annurev-bioeng-071114-040808 (2015).
[84] Chae, J. B. et al. Optimum thickness of hydrophobic layer for operating voltage reduction in EWOD systems. Sensors and Actuators A: Physical 215, 8-16, doi: https://doi.org/10.1016/j.sna.2013.11.001 (2014).
[85] Liu, H., Dharmatilleke, S., Maurya, D. K. & Tay, A. A. Dielectric materials for electrowetting-on-dielectric actuation. Microsystem technologies 16, 449-460 (2010).
[86] Zhu, S., Yi, H., Ni, Z. & Song, C. in 2007 IEEE/ICME International Conference on Complex Medical Engineering. 1720-1725.
[87] Bansal, S. & Sen, P. Effect of electrowetting induced capillary oscillations on coalescence of compound droplets. Journal of Colloid and Interface Science 530, 223-232, doi: https://doi.org/10.1016/j.jcis.2018.05.090 (2018).
[88] Wang, T., Andersen, S. I. & Shapiro, A. Coalescence of oil droplets in microchannels under brine flow. Colloids and Surfaces A: Physicochemical and Engineering Aspects 598, 124864, doi: https://doi.org/10.1016/j.colsurfa.2020.124864 (2020).
[89] Aarts, D. G. A. L., Lekkerkerker, H. N. W., Guo, H., Wegdam, G. H. & Bonn, D. Hydrodynamics of Droplet Coalescence. Physical Review Letters 95, 164503, doi: 10.1103/PhysRevLett.95.164503 (2005).
[90] Pitois, O., Moucheront, P. & Chateau, X. Liquid Bridge between Two Moving Spheres: An Experimental Study of Viscosity Effects. Journal of Colloid and Interface Science 231, 26-31, doi: https://doi.org/10.1006/jcis.2000.7096 (2000).
[91] Hartmann, J., Schür, M. T. & Hardt, S. Manipulation and control of droplets on surfaces in a homogeneous electric field. Nature Communications 13, 289, doi: 10.1038/s41467-021-27879-0 (2022).
[92] Zhang, R., Lin, H. & Shum, A. H. C. in 2023 MRS Fall Meeting.
[93] Ho, M. et al. Digital microfluidics with distance-based detection—a new approach for nucleic acid diagnostics. Lab on a Chip 24, 63-73, doi: 10.1039/D3LC00683B (2024).
[94] Anderson, S., Hadwen, B. & Brown, C. Thin-film-transistor digital microfluidics for high value in vitro diagnostics at the point of need. Lab on a Chip 21, 962-975, doi: 10.1039/DOLC01143F (2021).
[95] Au, S. H., Kumar, P. & Wheeler, A. R. A New Angle on Pluronic Additives: Advancing Droplets and Understanding in Digital Microfluidics. Langmuir 27, 8586-8594, doi: 10.1021/la201185c (2011).
[96] Srinivasan, V. A digital microfluidic lab-on-a-chip for clinical applications. PhD, Electrical and Computer Engineering, Duke University (2005).
[97] Fair, R. B. Digital microfluidics: is a true lab-on-a-chip possible? Microfluidics and Nanofluidics 3, 245-281, doi: 10.1007/s10404-007-0161-8 (2007).
[98] Srinivasan, V., Pamula, V. K., Pollack, M. G. & Fair, R. B. in Proc. MicroTAS. 1287-1290.
[99] Greene, C. et al. Blood-brain barrier disruption and sustained systemic inflammation in individuals with long COVID-associated cognitive impairment. Nature Neuroscience 27, 421-432, doi: 10.1038/s41593-024-01576-9 (2024).
[100] Jones, M. A., Totemeyer, S., Maskell, D. J., Bryant, C. E. & Barrow, P. A. Induction of Proinflammatory Responses in the Human Monocytic Cell Line THP-1 by <i>Campylobacter jejuni</i>. Infection and Immunity 71, 2626-2633, doi: doi: 10.1128/iai.71.5.2626-2633.2003 (2003).
[101] Broderick, L. & Hoffman, H. M. IL-1 and autoinflammatory disease: biology, pathogenesis and therapeutic targeting. Nature Reviews Rheumatology 18, 448-463, doi: 10.1038/s41584-022-00797-1 (2022).
[102] Kashiwagi, K. et al. Nano-cluster-enhanced high-performance perfluoro-polymer electrets for energy harvesting. Journal of Micromechanics and Microengineering 21, 125016, doi: 10.1088/0960-1317/21/12/125016 (2011).
[103] Suzuki, Y. Recent progress in MEMS electret generator for energy harvesting. IEEJ Transactions on Electrical and Electronic Engineering 6, 101-111, doi: https://doi.org/10.1002/tee.20631 (2011).

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A droplet gripper for a polarizable droplet comprising:
a top plate formed of magnetically responsive material and movable in a defined sequence in response to movement of a regionalized electromagnetic field; and
electret sheets downwardly depending from the top plate, said electret sheets being chargeable to the same polarity and being spaced apart sufficiently for a droplet to be located between them;
whereby the droplet is attracted by the electret sheets due to electret-induced polarization on droplet (EPD) and is moved with the top plate.

2. The droplet gripper of claim 1 wherein the top plate has a square shape and there at least four electret sheets, one of said electret sheets downwardly depending from each side of the square top plate, and
wherein the electret sheets downwardly depending from opposite sides of the top plate have the same charge polarities.

3. The droplet gripper of claim 2 wherein the electret sheets are made of PTFE and is negatively charged by contact electrification with copper.

4. The droplet gripper of claim 2 wherein the electret sheets are made of glass and are positively charged by contact electrification with PTFE.

5. A Multiphysics droplet robotic system for automatically manipulating and moving a liquid droplet, comprising:
EPD grippers as claimed in claim 1; and
a programmable control matrix that generates a regionalized electromagnetic field through coils, said regionalized electromagnetic field varying in a defined sequence according to a program of the control matrix so as to move the EPD gripper in a specific path and the EPD gripper can drive droplets in the specific path as well as achieve other microfluidic operations.

6. The Multiphysics droplet robotic system of claim 5 wherein the other microfluidic operations are one of self-assembly, merging of two droplets and mixing of the merged droplets by cyclic motion.

7. The Multiphysics droplet robotic system of claim 5 wherein the programmable magnetic field can actuate EPD grippers, inducing a mobile non-uniform electrostatic field capable of attracting the droplet below.

8. The Multiphysics droplet robotic system of claim 5 wherein the programmable control matrix is fabricated on a multilayer PCB, composed of row switches, column switches, an electromagnetic coil matrix and a signal/power socket.

9. The Multiphysics droplet robotic system of claim 5 further including an extra actuation magnet on the top plate used to amplify the electromagnetic field generated by the control matrix, balancing the weight of the EPD gripper.

10. A method of operating the Multiphysics droplet robotic system of claim 5, comprising the steps of:
uploading a command to the control matrix;
power designated coils;
generate localized magnetic field;
actuate EPD gripper by magnetic force;
move EPD gripper in a specific path; and
actuate droplet by EPD.

11. A method of lithium monitoring in multiple body fluids, comprising the steps of:
providing a microfluidic detection chip with three reagent loading areas divided in to load masking, probe, and buffer solution, respectively, and three working regions for merging, mixing, and reacting these reagents with calibration samples/testing samples, respectively
using two in-situ calibrations and one sample detection as a group;
preloading the two working areas for in-situ calibration two calibration samples of known lithium concentration;
preloading a masking solution;
providing three of the EPD grippers of claim 1 programmed to work collaboratively to implement the steps of the automated assay within the detection chip, including sample preparation, calibration 1, calibration 2, and sample detection;
each EPD gripper executing the tasks and moving according to their trajectories step-by-step along;
in a sample preparation stage (step 0-2), after loading the tested real bio-sample onto the chip, causing the EPD gripper 1 and 2 to transport the sample and masking solution to the sample region for mixing;
in a second stage of Calibration 1 (step 3-7), injecting buffer and probe solutions into the chip, respectively (step 3 and 5),
causing EPD gripper 2 and 3 to capture generated sub-droplets and transport them to the calibration region to mix with the prepared calibration sample (step 4 and 6);
allowing lithium ions within the sample to bind to the probe after dilution, thereby shifting the absorbance profiles quantitatively (step 7);
causing the generation, transporting and mixing process of buffer and probe solutions to be repeated for the third stage of Calibration 2 and the fourth stage of Sample detection, respectively (step 8 and 9), whereby two in-situ calibrations and one real bio-sample detection are performed automatically, and the concentration of lithium in the bio-sample is calculated based on a linear calibration curve.
